(19) United States
(12) Patent Application Publication
(10) Pub. No.: US 2007/0110348 A1
(43) Pub. Date: May 17, 2007

(54) Fluid dynamic bearing unit

(76) Inventor: Rikuro Obara, Kitasaku-gun (JP)

Correspondence Address: SCHULTE ROTH & ZABEL LLP;ATTN: JOEL E. LUTZKER, 919 THIRD AVENUE, NEW YORK, NY, 10022, US

(21) Appl. No.: 10/571,238

(22) PCT Filed: Sep. 10, 2004
(86) PCT No.: PCT/US04/29676

§ 371 Date: Dec. 21, 2006

(30) Foreign Application Priority Data
Sep. 12, 2003 (JP) 2003-321807

(51) Int. Cl. F16C 32/06

(52) U.S. Cl. 384/107

(57) ABSTRACT

A fluid dynamic bearing unit comprised of a plurality of modularized elements that are combined is provided with a case element 10, an end plate element 20, a first outer ring element 30, a second outer ring element 80, a flangeattached shaft element 40, and a spacer element 100. On the inner circumferential surface of the first outer ring element 30 and the inner circumferential surface of the second outer ring element 80, a first dynamic pressure groove 91 and a second dynamic pressure groove 92 are formed to generate dynamic pressure that supports a load in the radial direction. On the upper end surface of the second outer ring element 80 and on the upper surface of an end plate element 20, a third dynamic pressure groove 93 and a fourth dynamic pressure groove 94 are formed to generate dynamic pressure that supports a load in the axial direction. Lubricating oil is filled into the minute gaps corresponding to each of these dynamic pressure grooves. The elements on which the dynamic pressure grooves are formed are made from steel, or stainless steel, which can be hardened. The fluid dynamic bearing units being suitable for use in a hard disk drive such a HDD or DVD.

### BACKGROUND OF THE INVENTION

1. Field Of The Invention

The present invention relates to a fluid dynamic bearing unit for both radial and axial bearing loads. In particular, the present invention relates to a standardized fluid dynamic bearing unit made from modularized components and unitized completed components. The bearing unit being suitable for use in, for example, hard disk drives (HDD's) or Digital Versatile disc drives (DVD's).

2. Description of Related Art

In recent years, spindle motors have been used as driving devices or components for the rotational parts in office automation equipment such as computers and hard disk drives. These devices, over time, have continuously increased capacity and have been miniaturized. For spindle motors used in these devices, high reliabilities for motor fluctuation accuracy (NRRO (asynchronous fluctuation)), noise, sound duration, rigidity, and the like are strongly desirable.

In the past, for the axle bearing of the rotating axis of this type of spindle motor, a compound ball bearing device, which is made by combining a plurality of a ball bearing, was widely used. Incidentally, recently, for hard disk drives, there has been an even stronger demand for an increase in recording capacity, an improvement in impact load carrying capacity, low noise and an acceleration of data access speed. To respond to these demands, there is an attempt to improve materials and the engineering precision of the inner and outer rings and rotating body of the ball bearing. However, these measures alone are not sufficient, and the limitations of roller bearings themselves have come to be recognized. In order to respond to these limitations, the use of fluid dynamic bearings has been implemented.

FIG. 11 shows an axle rotating spindle motor using a fluid dynamic bearing. This spindle motor 00 comprises a base 02, a rotor hub 03 supported by the base 02, and a fluid dynamic bearing device 01 placed between the base 02 and the rotor hub 03.

A sleeve 010 of the fluid dynamic bearing device 01 is fitted into and fixed to an inner circumferential surface of a cylindrical wall 07 of the central part of the base 02, and a rotating axle 030, which is perpendicular to the rotor hub 03, is fitted into this sleeve 010. A minute gap between the sleeve 010 and the rotating axle 030 is filled with lubricating oil, and pressure is generated in the lubricating oil by both the rotation of the rotating axle 030, and the action of dynamic pressure grooves (for example, herringbone type grooves) 051 and 052, which were formed on the inner circumferential surface of the sleeve 010. The dynamic pressure caused by action of the dynamic pressure grooves 051 and 052 freely supports the rotation of the rotating axle 030 in the radial direction while the rotating axle 030 does not contact the inner circumferential surface of the sleeve 010. The dynamic pressures grooves 051 and 052 are formed at the upper and lower inner circumferential surface of the sleeve 010. Instead, these dynamic pressure grooves can be formed on the outer circumferential surface of the rotating axle 030.

The details are not shown in FIG. 11, but a dynamic pressure grooves (for example, herringbone type grooves) are formed on a upper surface of a counter plate 020 and a lower end surface of the sleeve 010, both of which respectively face a lower end surface and a upper end surface of a thrust ring 060, which is fitted into a lower end part of the rotating axle 030. A minute gap is formed between the opposing surfaces adjacent each dynamic pressure groove. Lubricating oil is filled in each gap, and pressure is generated in the lubricating oil by the rotation of the rotating axle 030. The dynamic pressure caused by action of these dynamic pressure grooves, freely supports rotation of the thrust ring 060 in the axial direction while the thrust ring 060 does not contact with the upper surface of the counter plate 020 or the lower end surface of the sleeve 010. These dynamic pressure grooves can be formed on the lower end surface and the upper end surface of the thrust ring 060.

Consequently, the base 02 freely supports the rotation of the rotating axle 030 of the rotor hub 03, by means of the fluid dynamic bearing device 01. In addition, the structure of the motor, which includes a stator 05, a permanent magnet 06, etc., is no different from a spindle motor that uses conventional compound ball bearings.

In the past, since the component parts such as the sleeve 010, the rotating axle 030, the counter plates 020, and the like were not modularized, when fluid dynamic bearing devices as component parts of driving devices were required, each of these fluid dynamic bearing devices 01 had to be individually manufactured by each manufacturer conforming to the structure and performance required for each equipment or device. Thus, it was not easy to quickly manufacture a large quantity of fluid dynamic bearing devices with high performance and high reliability.

In the meantime, a number of proposals at the level of the spindle motor for this problem have been made. By modularizing as many components of a spindle motor as possible, and by making components that contain fluid dynamic bearing devices the common components, entirety of completed components are unitized so that the common components can be used as-is even when component's specifications and equipment types are diversified. By enabling the exchange of only the relevant components, when some components become defective, good components are re-utilized, and the cost is reduced. (see References: Unexamined Patent Application 2000-175405 Official Gazette (Kokai 2000-175405), Examined Utility Model Application S56-157427 Official Gazette (Examined S56-157427), Examined Utility Model Application S56-133121 Official Gazette (Examined S56-133121)) Furthermore, “components” as referred here include not only “a component of the smallest unit” but also “assembled components” that are made by combining a plurality of “a component of the smallest unit”.

However, the structures and dimensions of these modularized components are specified, first and foremost, for adapting to these spindle motors and are not standardized for various equipment and devices to be commonly used. Thus, it is desirable to have standardized fluid dynamic bearings made from modularized components that are suitable for use in various type of machine or device.

### SUMMARY OF THE INVENTION

The invention of this application solves the above-mentioned problems of the existing conventional fluid dynamic bearing devices by modularizing the fluid dynamic bearing device and using the “completed product” (assembled component). The fluid dynamic bearing of this invention is easy to manufacture and is standardized so that it is possible to use it in various type of machine or device including a hard disk drive. These fluid dynamic bearing units provide appropriate assembly, the desired structure and functionality, and provide the structure in concert with unitization, and especially, show bearing functionality corresponding to load in both radial and axial directions.

A fluid dynamic bearing unit of one embodiment of the present invention is composed of a combination of a plurality of modularized elements, having a plurality of dynamic pressure generation mechanism parts, and freely supporting relative rotation of a flange-attached shaft element having a flange part at one end. The fluid dynamic bearing comprises a tubular case element having a cylindrical shaped inner circumferential surface, an end plate element closinging a lower end of the case element, an outer ring element fitted into the case element; and a flange-attached shaft element inserted into the outer ring element so that the flange part thereof is located between a lower end surface of the outer ring element and an upper surface of the end plate element. A first dynamic pressure groove is formed on an inner circumferential surface of the outer ring element or an outer circumferential surface of the main body of the flange-attached shaft element to cause the generation of dynamic pressure which receives the load in the radial direction between both of these facing surfaces, i.e., the inner circumferential surface and the outer circumferential surface. A second dynamic pressure groove is formed on a lower end surface of the outer ring element or an upper surface of the flange part of the flange-attached shaft element to cause the generation of dynamic pressure, which receives the load in the axial direction. A third dynamic pressure groove is formed on an upper surface of the end plate element or a lower surface of the flange part of the flange-attached shaft element to cause the generation of dynamic pressure which receives the load in the axial direction. Lubricating oil is filled in the minute gap between each of the facing surfaces corresponding to the first dynamic pressure groove, the second dynamic pressure groove, as well as the third dynamic pressure groove.

A fluid dynamic bearing unit of another embodiment of the present invention is composed of a combination of a plurality of modularized elements, having a plurality of dynamic pressure generation mechanism parts, and freely supporting relative rotation of a straight shaft element. The fluid dynamic bearing comprises a tubular case element having a cylindrical shaped inner circumferential surface and an outer ring element fitted into the tubular case element. A shaft element is inserted into the outer ring element. A first dynamic pressure groove is formed on an inner circumferential surface of the outer ring element or an outer circumferential surface of the shaft element to cause the generation of dynamic pressure which receives the load in the radial direction. A second dynamic pressure groove is formed on an upper surface of the end plate element or a lower surface of the shaft element to cause the generation of dynamic pressure, which receives the load in the axial direction. Lubricating oil is filled in the minute gap between each of the facing surfaces corresponding to the first dynamic pressure groove as well as the second dynamic pressure groove.

A fluid dynamic bearing unit of another embodiment of the present invention is composed of a combination of a plurality of modularized elements, having a plurality of dynamic pressure generation mechanism parts, and freely supporting relative rotation of a flange-attached shaft element having a flange part at one end. The fluid dynamic bearing comprises a tubular case element having a cylindrical shaped inner circumferential surface, an end plate element closing the lower end part of the case element, an outer ring element fitted into the case element and an inner ring element inserted into the outer ring element. A flange-attached shaft element is fitted into the inner ring element in such a way that the flange part thereof is located between a lower end surface of the outer ring element as well as a lower end surface of the inner ring element and an upper surface of the end plate element. A first dynamic pressure groove is formed on an inner circumferential surface of the outer ring element or an outer circumferential surface of the inner ring element to cause the generation of dynamic pressure which receives the load in the radial direction. A second dynamic pressure groove is formed on a lower end surface of the outer ring element or an upper surface of the flange part of the flange-attached shaft element to cause the generation of dynamic pressure, which receives the load in the axial direction. A third dynamic pressure groove is formed on an upper surface of the end plate element or a lower surface of the flange part of the flange-attached shaft element to cause the generation of dynamic pressure which receives the load in the axial direction. Lubricating oil is filled in the minute gap between each of the facing surfaces corresponding to the first dynamic pressure groove, the second dynamic pressure groove, and the third dynamic pressure groove.

A fluid dynamic bearing unit of another embodiment of the present invention is composed of a combination of a plurality of modularized elements having a plurality of dynamic pressure generation mechanism parts, and freely supporting relative rotation of a straight shaft element. The fluid dynamic bearing comprises a tubular case element having a cylindrical shaped inner circumferential surface, an end plate element closing the lower end part of the case element, an outer ring element fitted into the case element, a flange-attached inner ring element having a flange part at one end inserted into the outer ring element in such a way that the flange part of the flange-attached inner ring element is located between a lower end surface of the outer ring element and an upper surface of the end plate element. A shaft element is fitted into the flange-attached inner ring element. A first dynamic pressure groove is formed on an inner circumferential surface of the outer ring element or an outer circumferential surface of the main body of the flange-attached inner ring element to cause the generation of dynamic pressure which receives the load in the radial direction. A second dynamic pressure groove is formed on a lower end surface of the outer ring element or an upper surface of the flange part of the flange-attached inner ring element to cause the generation of dynamic pressure, which receives the load in the axial direction. A third dynamic pressure groove is formed on an upper surface of the end plate element or a lower surface of the flange part of the flange-attached inner ring element to cause the generation of dynamic pressure which receives the load in the axial direction. Lubricating oil is filled in the minute gap between each of the facing surfaces corresponding to the first dynamic pressure groove, the second dynamic pressure groove, as well as the third dynamic pressure groove.

A fluid dynamic bearing unit of another embodiment of the present invention is composed of a combination of a plurality of modularized elements, having a plurality of dynamic pressure generation mechanism parts, and freely supporting relative rotation of a flange-attached shaft element having a shaft part in a middle section. The fluid dynamic bearing comprises a tubular case element having a cylindrical shaped inner circumferential surface, an end plate element closing the lower end part of the case element, a first outer ring element as well as a second outer ring element both fitted into the case element and a flange-attached shaft element inserted into the first outer ring element as well as the second outer ring element in such a way that the flange part thereof is located between a lower end surface of the first outer ring element and an upper surface of the second outer ring element. A first dynamic pressure groove is formed on an inner circumferential surface of the first outer ring element or an outer circumferential surface of the main body of the flange-attached shaft element to cause the generation of dynamic pressure which receives the load in the radial direction. A second dynamic pressure groove is formed on an inner circumferential surface of the second outer ring element or an outer circumferential surface of the main body of the flange-attached shaft element to cause the generation of dynamic pressure, which receives the load in the radial direction. A third dynamic pressure groove is formed on a lower surface of the first outer ring element or an upper surface of the flange part of the flange-attached shaft element to cause the generation of dynamic pressure which receives the load in the axial direction. A fourth dynamic pressure groove is formed on an upper surface of the second outer ring element or a lower surface of the flange part of the flange-attached shaft element to cause the generation of dynamic pressure which receives the load in the axial direction. Lubricating oil is filled in the minute gap between each of the facing surfaces corresponding to the first dynamic pressure groove, the second dynamic pressure groove, the third dynamic pressure groove, as well as the fourth dynamic pressure groove.

A fluid dynamic bearing unit of another embodiment of the present invention is composed of a combination of a plurality of a modularized element, having a plurality of dynamic pressure generation mechanism parts, and freely supporting relative rotation of a flange-attached shaft element having a flange part at one end. The fluid dynamic bearing comprises a tubular case element having a cylindrical shaped inner circumferential surface, an end plate element closing the lower end part of the case element, a first outer ring element as well as a second outer ring element both fitted into the case element, a flange-attached shaft element inserted into the first outer ring element as well as the second outer ring element in such a way that the flange part thereof is located between a lower end surface of the second outer ring element and an upper surface of the end plate element. A spacer element surrounds the flange part of the flange-attached shaft element and positions the second outer ring element relative to the end plate element. A first dynamic pressure groove is formed on an inner circumferential surface of the first outer ring element or an outer circumferential surface of the main body of the flange-attached shaft element to cause the generation of dynamic pressure which receives the load in the radial direction. A second dynamic pressure groove is formed on an inner circumferential surface of the second outer ring element or an outer circumferential surface of the main body of the flange-attached shaft element to cause the generation of dynamic pressure, which receives the load in the radial direction. A third dynamic pressure groove is formed on a lower surface of the second outer ring element or an upper surface of the flange part of the flange-attached shaft element to cause the generation of dynamic pressure which receives the load in the axial direction. A fourth dynamic pressure groove is formed on an upper surface of the end plate element or a lower surface of the flange part of the flange-attached shaft element to cause the generation of dynamic pressure which receives the load in the axial direction. Lubricating oil is filled in the minute gap between each of the facing surfaces corresponding to the first dynamic pressure groove, the second dynamic pressure groove, the third dynamic pressure groove, as well as the fourth dynamic pressure groove.

Another embodiment of a fluid dynamic bearing unit freely supports the relative rotation of a straight shaft element having multiple dynamic pressure generation mechanism parts. The fluid dynamic bearing unit is composed of a combination of multiple modularized elements, and includes a tubular case element having a cylindrical shaped inner circumferential surface, an end plate element that closes the lower end part of the above-mentioned case element, a first outer ring element as well as a second outer ring element fit into the above-mentioned case element, and a first inner ring element inserted into the above-mentioned first outer ring element. A second flange-attached inner ring element having a flange part at one end is inserted into the above-mentioned second outer ring element so that the flange part thereof is sandwiched between the lower end surface of the second outer ring element and the upper surface of the end plate. A shaft element is fit into the first inner ring element and the second flange-attached inner ring element. A first dynamic pressure groove is formed on the inner circumferential surface of the first outer ring element or the outer circumferential surface of the first inner ring element for generation of dynamic pressure that receives the load in the radial direction. A second dynamic pressure groove is formed in the inner circumferential surface of the second outer ring element or the inner circumferential surface of the second flange-attached inner ring element to cause the generation of dynamic pressure that receives the load in the radial direction. A third dynamic pressure groove is formed on the lower end surface of the second outer ring element or on the upper surface of the flange part of the second flange-attached inner ring element to cause the generation of dynamic pressure that receives the load of the axial direction. A fourth dynamic pressure groove is formed on the upper surface of the end plate element or on the lower surface of the flange part of the second flange-attached inner ring element to cause the generation of dynamic pressure that receives the load in the axial direction. Lubricating oil is filled in the minute gap between each of the facing surfaces of the first dynamic pressure groove, the second dynamic pressure groove, the third dynamic pressure groove and the fourth dynamic pressure groove.

Another embodiment of a fluid dynamic bearing unit freely supports the relative rotation of a stepped shaft element having a large diameter part and a small diameter part, and has multiple sets of dynamic pressure generation grooves. The fluid dynamic bearing unit is composed of a combination of multiple modularized elements, and is characterized by a tubular case element having a cylindrical shaped inner circumferential surface, an end plate element that closes the lower end part of the tubular case element and fits into the tubular case element, a first outer ring element having a cylindrical shaped inner circumferential surface of a large diameter and a second outer ring element having a cylindrical shaped inner circumferential surface of a small diameter. A stepped shaft element is inserted into the first outer ring element and the second outer ring element so that large diameter part thereof is inserted into the first outer ring element, and the small diameter part thereof is inserted into the second outer ring element. A first dynamic pressure groove is formed on the inner circumferential surface of the first outer ring element or the outer circumferential surface of the large diameter part of the stepped shaft element to cause the generation of dynamic pressure that receives the load of the radial direction. A second dynamic pressure groove is formed in the inner circumferential surface of the second outer ring element or the outer circumferential surface of the small diameter part of the stepped shaft element to cause the generation of dynamic pressure that receives the load of the radial direction. A third dynamic pressure groove is formed on the upper end surface of the second outer ring element or on the surface of the step part of the stepped shaft element to cause the generation of dynamic pressure that receives the load of the axial direction. Lubricating oil is filled in the minute gap between each of the facing surfaces of the first dynamic pressure groove, the second dynamic pressure groove and the third dynamic pressure groove.

Another embodiment of a fluid dynamic bearing unit freely supports the relative rotation of a stepped shaft element having a small diameter part and a large diameter part and having multiple sets of dynamic pressure generation grooves. The fluid dynamic bearing is composed of a combination of multiple modularized elements and is characterized by a tubular case element having a cylindrical shaped inner circumferential surface, an end plate element that closes the lower end part of the above-mentioned case element and fit into the above-mentioned case element, a first outer ring element having a small diameter cylindrical inner circumferential surface as well as a second outer ring element having a large diameter cylindrical inner circumferential surface. A stepped shaft element is inserted into the first outer ring element as well as the second outer ring element so that the small diameter part thereof is inserted into the first outer ring element and the large diameter part thereof is inserted into the second outer ring element. A first dynamic pressure groove is formed on the inner circumferential surface of the first outer ring element or the outer circumferential surface of the small diameter part of the stepped shaft element to cause the generation of dynamic pressure that receives the load of the radial direction. A second dynamic pressure groove is formed in the inner circumferential surface of the second outer ring element or the outer circumferential surface of the large diameter part of the stepped shaft element to cause the generation of dynamic pressure that receives the load of the radial direction. A third dynamic pressure groove is formed on the lower end surface of the first outer ring element or on the surface of the step part of the stepped shaft element to cause the generation of dynamic pressure that receives the load of the axial direction. A fourth dynamic pressure groove is formed on the upper surface of the end plate element or on the lower end surface of the stepped shaft element to cause the generation of dynamic pressure that receives the load of the axial direction. Lubricating oil is filled in the minute gap between each of the facing surfaces of the first dynamic pressure groove, the second dynamic pressure groove, the third dynamic pressure groove and the fourth dynamic pressure groove.

In the above embodiments of the fluid dynamic bearing, the elements on which the dynamic pressure grooves are formed are made of steel that can be hardened or stainless steel that can be hardened. The dynamic pressure grooves are formed on these elements, after the elements are heat treated and ground, by means of electrochemical machining.

Furthermore, in the above embodiments of the fluid dynamic bearing, a step part is formed in the lower end part of the case element, the end plate element is fit together with said step part, and the lower end part of the case element is made so as to be closed. Exceptional accuracy is obtained due to the fact that grinding of the inner circumferential surface of the case element and the step part can be done at the same time in one setting. The right angle between the upper surface of the end plate and the shaft center of the case element becomes easy to produce, the assembly accuracy of each element that forms the fluid dynamic bearing unit is improved, and high relative rotational accuracy of the shaft element is obtained.

Further features and advantages will appear more clearly on a reading of the detailed description, which is given below by way of example only and with reference to the accompanying drawings wherein corresponding reference characters on different drawings indicate corresponding parts.

### BRIEF DESCRIPTION OF THE DRAWINGS

FIG. 1 is a cross-sectional view of the fluid dynamic bearing unit of embodiment 1.

FIG. 2 is a cross-sectional view of the fluid dynamic bearing unit of embodiment 2.

FIG. 3 is a cross-sectional view of the fluid dynamic bearing unit of embodiment 3.

FIG. 4 is a cross-sectional view of the fluid dynamic bearing unit of embodiment 4.

FIG. 5 is a cross-sectional view of the fluid dynamic bearing unit of embodiment 5.

FIG. 6 is a cross-sectional view of a variation example of the fluid dynamic bearing unit of embodiment 5.

FIG. 7 is a cross-sectional view of the fluid dynamic bearing unit of embodiment 6.

FIG. 8 is a cross-sectional view of the fluid dynamic bearing unit of embodiment 7.

FIG. 9 is a cross-sectional view of the fluid dynamic bearing unit of embodiment 8.

FIG. 10 is a cross-sectional view of the fluid dynamic bearing unit of embodiment 9.

FIG. 11 is a cross-sectional view of a spindle motor used by a conventional fluid dynamic bearing device.

### DETAILED DESCRIPTION

Formerly, fluid dynamic bearings, due to various obstacles (such as the supply system of the constituent parts, the assembly system of the bearings) were only used in limited technical areas and applications. The present invention, by making the constituent parts modularized and the completed product unitized, achieves standardization. Thus, easily supplying and making it possible to use the fluid dynamic bearings of various types and various specifications desired by engineers engaged in the development of products such as machines and devices including hard disk drives(HDD's) and digital versatile disk drives (DVD's).

According to the present invention, fluid dynamic bearing units of various standardized specifications, which can be used in various machines and devices, become easy to manufacture. Regardless of the kind of machine and device, the manufacturer of these machine and device will be able to immediately procure various elements of the fluid dynamic bearing units or the constituent parts thereof, when necessary, to assemble the fluid dynamic bearing units with the desired structure and dynamic pressure bearing function (including bearing rigidity with respect to the both the radial and axial direction loads). Selecting the optimum design from the viewpoint of the use of the bearing device and the desired structure becomes easy.

A fluid dynamic bearing unit according to the present invention freely supports the relative rotation of shaft elements of various shapes such as a flange-attached shaft element having a flange part at one end, a straight shaft element, a flange-attached shaft element having a flange part in the middle part and a stepped shaft element having a large diameter part and a small diameter part. The fluid dynamic bearing unit is broken down into multiple elements that are easy to modularize such as a case element, an end plate element, an outer ring element, a first outer ring element, a second outer ring element, an inner ring element, a flange-attached inner ring element, a first inner ring element, a second inner ring element, a second flange-attached inner ring element, a spacer element, and a shaft element. The inside of a bearing container is formed by one end part of a case element closed by the end plate element and other parts of various specifications from the parts listed above appropriately mutually assembled, collected and fixed. A dynamic pressure groove for the purpose of generating a dynamic pressure that receives the load in the radial direction or the axial direction on the prescribed surface of a prescribed element is formed. In the minute gaps between the opposing surfaces, one of which surface is the dynamic pressure groove, lubricating oil is filled in. And, at least, the elements in which a dynamic pressure groove is formed are manufactured from steel that can be hardened or stainless steel that can be hardened, and after the heat treatment has been performed and the grinding has been finished, the dynamic pressure groove is formed by means of electrochemical machining.

Done in this way, a fluid dynamic bearing unit provided with the desired structure and dynamic pressure bearing function (including bearing rigidity with respect to the load of the radial and axial directions) is obtained. The following embodiments are some examples of the standardized modular fluid dynamic bearings of the present invention.

### Embodiment 1

Next, embodiment 1 of the invention of this application will be explained.

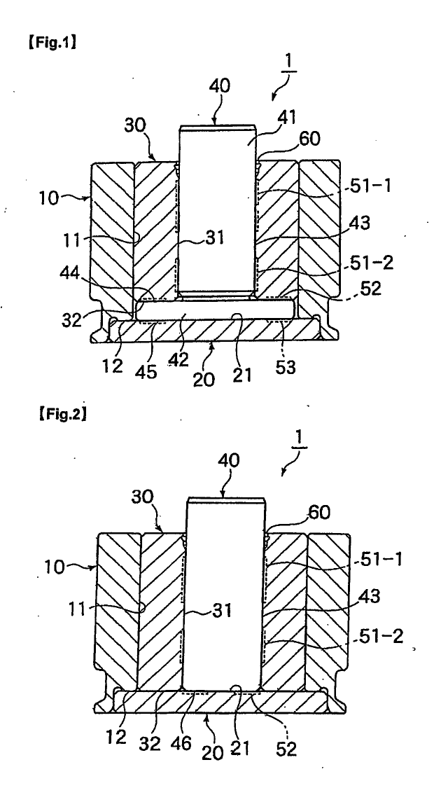

FIG. 1 is a cross-sectional view of embodiment 1 of a fluid dynamic bearing unit 1. The fluid dynamic bearing unit 1 freely supports relative rotation of a flange-attached shaft element 40 having a flange part 42 on one end (the lower edge in FIG. 1). The flange-attached shaft element 40 has a main part 41 having an outer circumferential surface 43. The flange part 42 has an upper surface 44 and a lower surface 45. The fluid dynamic bearing unit 1 has a tubular case element 10 having a cylindrical shaped inner circumferential surface 11, and a disc shaped end plate element 20 that closes the lower end part of the case element 10. A cylindrical shaped outer ring element 30 fits into the case element 10. The flange part 42 is arranged so as to be sandwiched between a lower end surface 32 of the outer ring element 30 and an upper surface 21 of the end plate element 20. The flange-attached shaft element 40 is inserted into the outer ring element 30. The end of the flange-attached shaft element 40 that is away from the end having the flange part 42 protrudes from the topside of the case element 10.

In the fluid dynamic bearing unit 1, generally, the flange-attached shaft element 40 rotates, but an integrated assembly body composed of the case element 10, the end plate element 20 and the outer ring element 30, may be made the rotating side. The fluid dynamic bearing unit 1 may be used with the illustrated up-down position reversed.

First dynamic pressure grooves, for example, grooves 51-1, 51-2, are formed on the inner circumferential surface 31 of the outer ring element 30. The first dynamic pressure grooves generate dynamic pressure between the outer circumferential surface 43 and the opposing inner circumferential surface 31. The dynamic pressure receives (i.e. supports) the load in the radial direction. A second dynamic pressure groove 52 is formed on the lower end surface 32. The Dynamic pressure generated between the upper surface 44 and the lower end surface 32 receives the axial direction load. A third dynamic pressure groove 53 is formed on the upper surface 21 of the end plate element 20. The first, second and third dynamic pressure grooves 51-1, 51-2, 52 and 53 are collectively referred to as dynamic pressure grooves 51, 52 and 53 hereafter. The dynamic pressure generated between the upper surface 21 and the lower surface 45 receives the axial direction load. These dynamic pressure grooves 51, 52 and 53, are formed in a herring bone shape, but the shape is not restricted at all, and being formed in a spiral shape, a circular arc shape, a straight line shape and the like is also acceptable.

The first dynamic pressure grooves 51-1 and 51-2, are formed in two places and are separated in the axial direction. This way the shaft element 40 obtains a high bearing rigidity, since the shaft element 40 is supported at two places in the axial direction. This is particularly advantageous when the axial direction dimension of the fluid dynamic bearing unit 1 is large. The first dynamic pressure grooves may be formed at only one place if the axial dimension of the case element 10 needs to be reduced.

A minute gaps is formed between each of the dynamic pressure grooves 51, 52 and 53 and a respective facing surface. Lubricating oil is filled in each of the gaps. The lubricating oil is filled from a lubricating oil seal mechanism part 60. This lubricating oil seal mechanism part 60 is a gap formed by the space between the outer circumferential surface 43 and the open end side of the outer ring element 30 having slightly widened diameter.

This gap of the lubricating oil seal mechanism part 60 has a bigger width than the width of the minute gap formed between each of the dynamic pressure grooves 51, 52 and 53 and the facing surface. Since the capillary force in the gap of this widened seal mechanism part 60 works as the holding force of the lubricating oil, the oil doesn't leak out via the gap of the seal mechanism part 60.

The elements on which the dynamic pressure grooves 51, 52 and 53 are formed, i.e., the outer ring element 30 and the end plate element 20, are manufactured from steel that can be hardened or stainless steel that can be hardened. The ring element 30 and the end plate element 20 are heat treated and ground. Because of the hardening, the dynamic pressure grooves 51, 52 and 53 are difficult to damage and their high dimensional accuracy can be maintained not only at the time of the assembly and at the time of handling of a single element, but also when the operation of a fluid dynamic bearing unit is suspended and at the time of rotation activation. Since the shape of the dynamic pressure grooves 51, 52 and 53 is maintained, the dynamic pressure bearing function as designed is exhibited. The dynamic pressure grooves 51, 52 and 53 are formed by means of electrochemical finishing to obtain fine surface roughness. In addition, by use of electrochemical machining, the machining time for the purpose of dynamic pressure groove formation can be shortened. After heat treatment, the inner circumferential surface 11, the outer circumferential surface and the surface of both ends of the case element 10 are finished by grinding. After the heat treatment the upper surface 21 and the outer circumference of the end plate 20 are finished by grinding. Furthermore, it is acceptable to manufacture the flange-attached shaft element 40 with the same kind of material, heat treat similarly, and finish by grinding. It is also acceptable to manufacture the end plate element 20 with normal stainless steel and carry out a coating of DLC (Diamond-Like Carbon) to raise the hardness of the surface.

The flange part 42 of the flange-attached shaft element 40 may be formed integral with the main body 41, or may be formed as a separate body and attached to the shaft element 40 by assembling by means of pressing in, bonding, caulking, welding and the like methods or using more than one of these methods at same time.

A step part 12 is formed in the lower end part of the case element 10. The outer circumferential edge part of the end plate element 20 is fit in the step part 12. The lower end part of the case element 10 is closed by the end plate element 20.

Since simultaneously grinding of the surfaces of the step part 12 that faces upper surface 21 and the inner circumferential surface 11 is possible, exceptional accuracy can be obtained. The accuracy makes perpendicularity of the upper surface 21 and the shaft center of the case element 10 easier to produce, improves the assembly accuracy of each element constituting the fluid dynamic bearing unit 1, and allows high relative rotation accuracy of the shaft element 40 to be obtained.

The assembly formed by the case element 10 closed by the end plate element 20 is called a bearing container. It is also possible to form this bearing container in one piece. A one piece bearing container also allows modularization. By making bearing container one piece, the number of elements is reduced by one, the work of fitting the end plate element 20 into the lower end part of the case element 10 is eliminated, and the structure and the assembly work of the fluid dynamic bearing unit 1 is simplified.

The outer ring element 30 is fitted into the case element 10 by means of shrink fitting, caulking, bonding or like methods. The assembly of the outer ring element 30 and the case element 10 rotates as a unit.

To maintain the dimensional relationships and the position relationships that exist at the time of assembly in all kinds of use environment temperatures, as far as possible, materials with small differences in the coefficient of linear expansion are selected. For same reasons, the planning and improvement of machining and assembly accuracy related to roundness, cylindricity, surface roughness, flatness, parallelism and the like are also important.

Furthermore, to manufacture standardized fluid dynamic bearing 1 that can be used in various kinds of machines and devices, the accuracy of the external shape, dimensions, surface properties of the case element 10 and the end plate element 20, the external diameter dimensions, surface properties and the like of the shaft element 40 also must be sufficiently paid attention to so that highly accurate fitting and attaching with the various kinds of machines and devices can be achieved. For same reasons finishing the roundness, cylindricity or cylindricality, surface roughness and the like to a high precision is necessary. Furthermore, the unevenness of the diameter of the elements and the width dimensions of these is reduced as far as possible.

In the fluid dynamic bearing 1, constituted as mentioned above, modularization of each element is easy and by means of each element being modularized in this way, a standardized fluid dynamic bearing unit is easily manufactured.

When the flange-attached shaft element 40 is constantly being pressed in an axial direction towards the endplate element 20 by means of a bias effect such as a magnetic force that works between a rotating side element and a fixed side element, appropriate clearance between the flange-attached shaft element 40 and adjacent surfaces during rotation of the flange-attached shaft element 40 and stability and improved rotation accuracy of the flange-attached shaft element 40 is obtained. Even in the absence of such bias effect, the dynamic pressure that is generated in the minute gap formed at the second dynamic pressure groove 52 and the third dynamic pressure groove 53 holds appropriate clearance between the flange-attached shaft element 40 and adjacent surfaces during rotation of the flange-attached shaft element 40, and stabilizes and improves the rotation accuracy of the flange-attached shaft element 40.

The dynamic pressure grooves 51, 52 and 53 are respectively formed in the inner circumferential surface 31, the lower end part 32 and the upper surface 21, but are not limited to these. Instead the dynamic pressure grooves 51, 52 and 53 may be formed on the complimentary surfaces, i.e., outer circumferential surface 43, the upper surface 44, and the lower surface 45 of the flange-attached shaft element 40. In this case also, elements in which dynamic pressure grooves are formed are manufactured from steel that can be hardened or stainless steel that can be hardened, and after being heat-treated and ground, the dynamic pressure grooves are formed by electrochemical machining. Even when the location of the dynamic pressure grooves 51, 52 and 53 is changed, the same effects as mentioned above can be produced.

### Embodiment 2

Next, embodiment 2 of the invention of this application will be explained.

FIG. 2 is a cross-sectional view of a fluid dynamic bearing unit 1 of embodiment 2. The fluid dynamic bearing unit 1 freely supports relative rotation of a shaft element 40. The shaft element 40 has a main part 41 having an outer circumferential surface 43. The fluid dynamic bearing unit 1 has a tubular case element 10 having a cylindrical shaped inner circumferential surface 11, and a disc shaped end plate element 20 that closes the lower end part of the case element 10. A cylindrical shaped outer ring element 30 fits into the case element 10. The shaft element 40 is inserted into the outer ring element 30.

First dynamic pressure grooves, for example grooves 51-1, 51-2, are formed on the inner circumferential surface 31 of the outer ring element 30. The first dynamic pressure grooves generate dynamic pressure between the outer circumferential surface 43 and an opposing inner circumferential surface 31 of the outer ring element 30. The dynamic pressure receives (i.e. supports) the load in the radial direction. A second dynamic pressure groove 52 is formed on an upper surface 21 of the end plate element 20. The Dynamic pressure generated between the upper surface 21 and a lower end part 46 of the shaft element 40 receives the axial direction load. Lubricating oil is filled in the minute gap formed between the first dynamic pressure grooves 51-1, 51-2, the second dynamic pressure groove 52 and the respective opposing surfaces.

The elements on which the dynamic pressure grooves are formed, i.e., the outer ring element 30 and end plate element 20, are manufactured from steel that can be hardened or stainless steel that can be hardened, and after being heat treated and ground, a first dynamic pressure groove 51-1, 51-2 and a second dynamic pressure groove 52 are formed by means of electrochemical machining.

Since the rest of the constitution does not differ from that of embodiment 1 a detailed explanation has been omitted.

In the fluid dynamic bearing 1 of the second embodiment, constituted as mentioned above, modularization of each element such as the case element 10, the end plate element 20, the outer ring element 30 and the straight shaft element 40 is easy and by means of each element being modularized in this way, a standardized fluid dynamic bearing unit is easily manufactured.

Furthermore, the outer ring element 30 and the end plate element 20 are manufactured from steel that can be hardened or stainless steel that can be hardened. The dynamic pressure grooves 51-1, 51-2, and 52 are formed on these elements in same manner as described in the context of the first embodiment and they exhibit same properties and advantages as described previously.

Furthermore, the fluid dynamic bearing unit 1 of this embodiment 2 is of simple constitution compared to that of embodiment 1, and is a suitable for use when it is not necessary to generate dynamic pressure in the axial direction in order to cause the shaft element to float to the extent required for the fluid dynamic bearing unit 1 of embodiment 1, and when the bias effect of a magnetic force and the like that works between the rotating side element and the fixed side element that always presses the shaft element 40 towards the end plate element 20 is expected. In addition, the same kind of effects as in embodiment 1 can be produced.

Furthermore, as in embodiment 1, first and second dynamic pressure grooves 51-1, 51-2 and 52 can be formed on the complimentary surface. In this case also, elements in which dynamic pressure grooves are formed are manufactured from steel that can be hardened or stainless steel that can be hardened, and after being heat-treated and ground, the dynamic pressure grooves are formed by electrochemical machining. Even when the location of the dynamic pressure grooves 51-1, 51-2 and 52 is changed, the same effects as mentioned above can be produced.

### Embodiment 3

Next, embodiment 3 of the invention of this application will be explained.

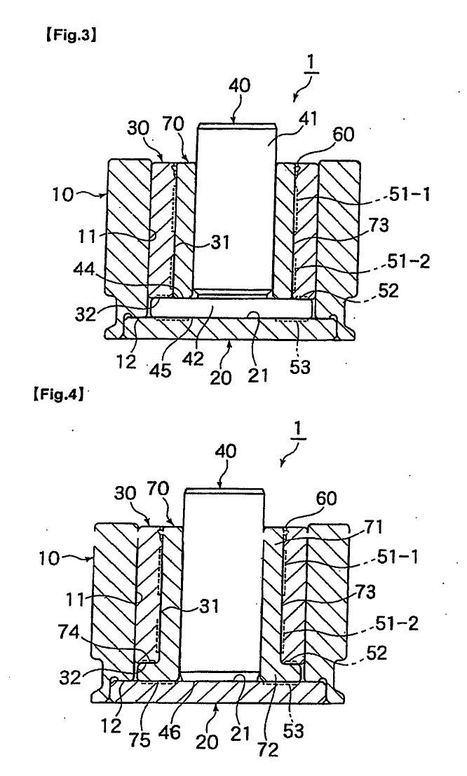

FIG. 3 is a cross-sectional view of a fluid dynamic bearing unit 1 of embodiment 3. The fluid dynamic bearing unit 1 of embodiment 3 differs from the fluid dynamic bearing unit 1 (FIG. 1) of embodiment 1 in that an outer ring element 30 of the third embodiment is thinner, and an inner ring element 70 is placed in the resulting space between a flange-attached shaft element 40 and the outer ring element 30. The inner ring element 70 rotates relative to the outer ring element 30. The flange-attached shaft element 40 is fit into the inner ring element 70 to form one unit therewith and rotates therewith. The inner ring element 70 and the outer ring element 30 form a bearing in the radial direction. The lower end of the inner ring element 70 contacts an upper surface 44 of a flange part 42 of the flange-attached shaft element 40.

First dynamic pressure grooves comprised of an upper dynamic pressure groove 51-1 and a lower dynamic pressure groove 51-2, the same as embodiment 1, are formed on an inner circumferential surface 31 of the outer ring element 30. A minute gap is formed between the dynamic pressure grooves 51-1, 51-2 and an outer circumferential surface 73 of the inner ring element 70. The second dynamic pressure groove 52 and the third dynamic pressure groove 53 are formed in same places as embodiment 1. Lubricating oil is filled into the minute gaps corresponding to the first dynamic pressure groove 51-1, 51-2, the second dynamic pressure groove 52 and the third dynamic pressure groove 53.

The dynamic pressure grooves 51-1, 51-2, 52 and 53 and the elements in which the dynamic pressure grooves 51-1, 51-2, 52 and 53 are formed are manufactured as previously disclosed in the context of first embodiment, and have the same properties and advantages.

The lubricating oil seal mechanism part 60 is a gap formed by the space between the outer circumferential surface 73 and the outer ring element 30 by means of the fact that the diameter of the open end side of the outer ring element 30 is slightly widened.

Since the rest of the constitution does not differ from that of embodiment 1, a detailed explanation has been omitted.

In the fluid dynamic bearing 1 of the third embodiment, constituted as mentioned above, modularization of each element such as the case element 10, the end plate element 20, the outer ring element 30, the inner ring element 70 and the straight shaft element 40 is easy and by means of each element being modularized in this way, a standardized fluid dynamic bearing unit is easily manufactured.

Furthermore, while using the same flange-attached shaft element 40, by changing the radial distance of the gap formed between the outer ring element 30 and the inner ring element 70, the dynamic pressure generated in this gap can be adjusted to suit the desired use conditions, i.e., the desired load in the radial direction. In addition, effects the same as those of embodiment 1 can be produced.

Furthermore, as in embodiment 3, first, second and third dynamic pressure grooves 51-1, 51-2, 52 and 53 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 51-1, 51-2, 52 and 53 are changed, the same effects as mentioned above can be produced.

### Embodiment 4

Next, embodiment 4 of the invention of this application will be explained.

FIG. 4 is a cross-sectional view of a fluid dynamic bearing unit 1 of embodiment 4. The parts that correspond to embodiment 2 arid embodiment 3 have the same reference numerals.

As illustrated in FIG. 4, the fluid dynamic bearing unit 1 of this embodiment 4, when compared to the fluid dynamic bearing unit 1 (FIG. 2) of embodiment 2, differs in that an outer ring element 30 is thinner, and a flange-attached inner ring element 70 is placed in the resulting space between a straight shaft element 40 and the outer ring element 30. The flange-attached inner ring element 70 rotates relative to the outer ring element 30. The shaft element 40 is fit into the inner ring element 70 to form one unit therewith and rotates therewith. The flange-attached inner ring element 70 and the outer ring element 30 form a bearing in the radial direction.

Furthermore, when compared to the fluid dynamic bearing unit 1 (FIG. 3) of embodiment 3, embodiment 4 differs in that instead of the flange-attached shaft element 40 of the fluid dynamic bearing unit 1 of embodiment 3, the straight shaft element 40 is used. Also, in place of the straight inner ring element 70, the flange-attached inner ring element 70 is used. A flange part 72 of the flange-attached inner ring element 70 is sandwiched between a lower end surface 32 of the outer ring element 30 and an upper surface 21 of an end plate element 20, and relative rotation with respect to these surfaces is possible.

A second dynamic pressure groove 52, similar to that in embodiment 3, is formed in the lower end surface 32 and faces an upper surface 74 of the flange part 72. Furthermore, a third dynamic pressure groove 53, similar to that in embodiment 3, is formed in the upper surface 21 of the end plate element 20 and faces a lower surface 75 of the flange part 72. The place where first dynamic pressure grooves 51-1, 51-2 are formed does not differ from embodiment 3. A minute gap is formed between each of the first, second and third dynamic pressure groove 51-1, 51-2, 52, 53 and the facing surfaces. Lubricating oil is filled into the minute gaps.

The dynamic pressure grooves 51-1, 51-2, 52 and 53 and the elements in which the dynamic pressure grooves 51-1, 51-2, 52 and 53 are formed are manufactured as previously disclosed in the context of first embodiment, and have the same properties and advantages. The flange-attached inner ring element 70 and the shaft element 40 also, can be manufactured from steel or stainless steel that can be heat treated, heat treated and ground.

Since the rest of the constitution does not differ from that of embodiment 3, a detailed explanation has been omitted.

In the fluid dynamic bearing 1 of the fourth embodiment, constituted as mentioned above, modularization of each element such as the case element 10, the end plate element 20, the outer ring element 30, the flange-attached inner ring element 70 and the straight shaft element 40 is easy and by means of each element being modularized in this way, a standardized fluid dynamic bearing unit is easily manufactured.

Furthermore, while using the same straight shaft element 40, by changing the radial distance of the gap formed between the outer ring element 30 and the inner ring element 70, the dynamic pressure generated in this gap can be adjusted to suit the desired use conditions, i.e., the desired load in the radial direction. In addition, effects the same as those of embodiment 3 can be produced.

Furthermore, as in embodiment 1, first, second and third dynamic pressure grooves 51-1, 51-2, 52 and 53 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 51-1, 51-2, 52 and 53 are changed, the same effects as mentioned above can be produced.

### Embodiment 5

Next, embodiment 5 of the invention of this application will be explained.

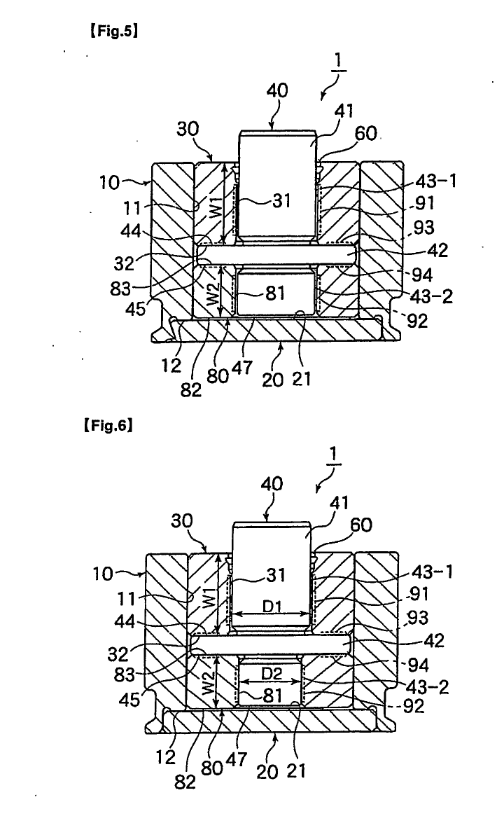

FIG. 5 is a cross-sectional view of a fluid dynamic bearing unit 1 of embodiment 5. As illustrated in the figure, the fluid dynamic bearing unit 1 of embodiment 5, when compared to the fluid dynamic bearing unit 1 (FIG. 1) of embodiment 1, differs in that a flange part 42 of a flange-attached shaft element 40 in the fluid dynamic bearing unit 1 of embodiment 5 is shifted to the middle part in the axis direction of the shaft element 40. The outer ring element 30 has been divided in two and positioned so that the flange part 42 is sandwiched from above and below.

Accordingly, in the embodiment 5, the two outer ring elements that sandwich the flange part 42 from above and below are a first outer ring element 30, and a second outer ring element 80. Reference numerals 81, 82, 83 refer to an inner circumferential surface, a lower end surface and an upper end surface of the second outer ring element 80, respectively. Reference numerals 43-1, 43-2, respectively, refer to a upper outer circumferential surface positioned in the upper part, and to a lower outer circumferential surface positioned in the lower part, of the flange part 42. Reference numeral 47 refers to a lower end part of the shaft element 40. New reference numerals 91, 92, 93 and 94 respectively refer to first, second, third and fourth dynamic pressure grooves. The same reference numerals are affixed to the other parts that correspond to embodiment 1.

The fluid dynamic bearing unit 1 of embodiment 5 freely supports relative rotation of the flange-attached shaft element 40 having the flange part 42 in the middle. The fluid dynamic bearing unit 1 includes a tubular case element 10 having a cylindrical inner circumferential surface 11, and a disc shaped end plate element 20 that closes the lower end part of the case element 10. The short cylindrical first outer ring element 30 and the second outer ring element 80 fit into the case element 10. The flange part 42 is sandwiched between a lower end surface 32 of the first outer ring element 30 and the upper end surface 83 of the second outer ring element 80. The flange-attached shaft element 40 is inserted into the first outer ring element 30 and the second outer ring element 80. The lower end surface 82 of the second outer ring element 80 contacts the upper surface 21 of the end plate element 20, but the lower end surface 47 of the flange-attached shaft element 40 slightly floats from the upper surface 21 of the end plate element 20.

The dynamic pressure groove 91 is formed on an inner circumferential surface 31 of the first outer ring element 30. The dynamic pressure groove 91 generates dynamic pressure between the upper outer circumferential surface 43-1 and the inner circumferential surface 31. This dynamic pressure receives the load in the radial direction. The dynamic pressure groove 92 is formed on the inner circumferential surface 81 of the second outer ring element 80. The dynamic pressure groove 92 generates dynamic pressure between the lower outer circumferential surface 43-2 and the inner circumferential surface 3 1. This dynamic pressure also receives the load in the radial direction. The dynamic pressure groove 93 is formed on the lower end surface 32 of the first outer ring element 30. The dynamic pressure groove 93 generates dynamic pressure between an upper surface 44 of flange part 42 and the lower end surface 32. This dynamic pressure receives the load in the axial direction. The dynamic pressure groove 94 is formed on the upper end surface 83 of the second outer ring element 80. The dynamic pressure groove 93 generates dynamic pressure between a lower surface 45 of flange part 42 and the upper end surface 83. This dynamic pressure receives the load in the axial direction. Lubricating oil is filled into each of the minute gap formed between each of the dynamic pressure groove 91, 92, 93 and 94 and respective opposing surface.

The dynamic pressure grooves 91, 92, 93 and 94 and the elements in which the dynamic pressure grooves 91, 92, 93 and 94 are formed, in embodiment 5, are manufactured as previously disclosed in the context of first embodiment, and have the same properties and advantages. Furthermore, manufacturing the flange-attached shaft element 40 with the same material as these elements, carrying out heat treatment in the same way, and grinding is also acceptable.

The flange part 42, formed in the middle, is integrated with the main body 41, but it is also possible to assemble flange part 42 on the flange-attached shaft element 40 by means of pressing in, bonding, caulking, welding and the like methods or using those methods at the same time.

The rest of the constitution does not differ from embodiment 1 and so a detailed explanation is omitted.

In the fluid dynamic bearing 1 of the fifth embodiment, constituted as mentioned above, modularization of each element such as the case element 10, the end plate element 20, the outer ring element 30, the second outer ring element 80, and the flange-attached shaft element 40 is easy and by means of each element being modularized in this way, a standardized fluid dynamic bearing unit is easily manufactured.

Furthermore, by changing the radial distance of the gap formed between the outer ring element 30 and the flange-attached shaft element 40, the dynamic pressure generated in this gap can be adjusted. Additionally, by changing the radial distance of the gap formed between the outer ring element 80 and the flange-attached shaft element 40, the dynamic pressure generated in this gap can be adjusted. Thus, the dynamic pressure generated in these two gaps can be adjusted to suit the desired use conditions, i.e., the desired load in the radial direction.

Furthermore, in a fluid dynamic bearing unit 1 of the same height, by variously changing the ratio of the axial direction dimension of the upper part and the axial direction dimension of the lower part of the main body 41 of the flange-attached shaft element 40, and in proportion thereto variously changing and combining the axial direction height W1 of the outer ring element 30 and the axial direction height W2 of the outer ring element 80, it is possible to adjust the dynamic pressure that receives the load in the radial direction to suit a desired use condition.

Furthermore, by variously changing the axial direction height W1, the axial direction height W2 and correspondingly changing the axial direction position of the flange part 42 the dynamic pressure generation position that receives the load of the axial direction can be adjusted to suit the axial direction center of gravity position of all the rotating bodies including the rotating side elements. This reduces the movement that knocks down the flange-attached shaft element 40 and the whirling vibration attributable to the gyroscopic movement of the flange-attached shaft element 40. The rotation of the flange-attached shaft element 40 can be stabilized, and the rotation accuracy can be improved.

Furthermore, if the dynamic pressure generated is equal to the load in the axial direction, a more effective reduction of the whirling vibration attributable to the gyroscopic movement of the flange-attached shaft element 40 becomes possible. Furthermore, when the reduction effect equal to that whirling vibration is desired, it can be achieved by the generation of a smaller dynamic pressure by means of adjusting, as described above, the dynamic pressure generation position that receives the axial direction load. By means of this, power consumption can be reduced.

When the shaft element 40 is not constantly being pressed in an axial direction by means of a bias effect such as a magnetic force between a rotating side element and a fixed side element, the dynamic pressure that is generated in the minute gap corresponding to dynamic pressure grooves 93 and 94 holds appropriate clearance between the flange-attached shaft element 40 and the adjacent surfaces and stabilizes and improves the rotation accuracy of the flange-attached shaft element 40. In addition, the same effects as in embodiment 1 can be produced.

Furthermore, as in embodiment 1, the dynamic pressure grooves 91, 92, 93 and 94 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 91, 92, 93 and 94 are changed, the same effects as mentioned above can be produced.

Next, examples of variations of embodiment 5 will be explained.

In this embodiment 5, as illustrated in FIG. 6, the diameter D1 of one half (upper half in the figure) bordered by the flange part 42 and diameter D2 of the other half (lower half in the figure) can be varied so as to be different. In the example shown in FIG. 6 D1>D2, but is not limited thereto. The degree of freedom for adjustment of the pressure that receives the load in the radial direction can be further increased as illustrated in the example of FIG. 6.

Furthermore, in the dynamic pressure generation part formed in the gap in the radial direction formed by the second outer ring element 80 and the small diameter main body 41 (small diameter radial pressure bearing part), since the small diameter can reduce the friction loss, bearing failure torque is reduced and power consumption can be reduced (converted to low power consumption).

In addition, due to the fact that friction loss is reduced in the radial pressure bearing part of the small diameter, the movement that acts in the direction that knocks down the flange-attached shaft element 40 is reduced. Thus, the whirling vibration due to the gyroscopic movement of the flange-attached shaft element 40 is reduced, the relative rotation thereof is stabilized and an improvement of rotational stability is provided for.

### Embodiment 6

Next, embodiment 6 of the invention of this application will be explained.

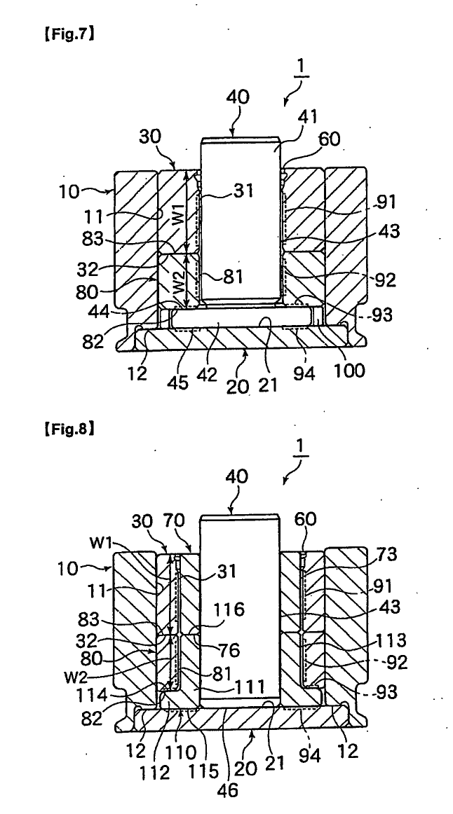

FIG. 7 is a cross-sectional view of a fluid dynamic bearing unit of embodiment 6. The same reference numerals are affixed to the parts that correspond to embodiment 5 and embodiment 1.

As illustrated in FIG. 7, the fluid dynamic bearing unit 1 of embodiment 6, when compared to the fluid dynamic bearing unit 1 of embodiment 5 (FIG. 5), differs in that a flange part 42 of a flange-attached shaft element 40 of the fluid dynamic bearing unit 1 of embodiment 6 has been shifted to one end part (lower end part) of the flange-attached shaft element 40, and in order to position a second outer ring element 80 with respect to an end plate element 20, a ring shaped spacer element 100 is provided. This ring shaped spacer element 100 is disposed so as to surround the flange part 42 of the flange-attached shaft element 40.

Consequently, the fluid dynamic bearing unit 1 of embodiment 6 freely supports the relative rotation of a flange-attached shaft element 40 having the flange part 42 on one end. A case element 10 of the fluid dynamic bearing unit I has the end plate element 20, a first outer ring element 30 and the second outer ring element 80 fit into the case element 10. The flange-attached shaft element 40 is inserted into the first outer ring element 30 and the second outer ring element 80 with the flange part 42 thereof sandwiched between the lower end surface 82 of the second outer ring element 80 and an upper surface 21 of the end plate element 20. A ring shaped spacer element 100 is provided so as to surround the flange part 42 of the flange-attached shaft element 40.

A dynamic pressure groove 91 is formed on the inner circumferential surface 31 of the first outer ring element 30. The dynamic pressure groove 91 generates dynamic pressure between the outer circumferential surface 43 and the inner circumferential surface 31. This dynamic pressure receives the load in the radial direction. The dynamic pressure groove 92 is formed on the inner circumferential surface 81 of the second outer ring element 80. The dynamic pressure groove 92 generates dynamic pressure between the outer circumferential surface 43 and the inner circumferential surface 81. This dynamic pressure also receives the load in the radial direction. The dynamic pressure groove 93 is formed on the lower end surface 82 of the second outer ring element 80. The dynamic pressure groove 93 generates dynamic pressure between an upper surface 44 of the flange part 42 and the lower end surface 82. This dynamic pressure receives the load in the axial direction. The dynamic pressure groove 94 is formed on the upper surface 21 of the end plate element 20. The dynamic pressure groove 94 generates dynamic pressure between a lower surface 45 of flange part 42 and the upper surface 21. This dynamic pressure receives the load in the axial direction. Lubricating oil is filled into each of the minute gap formed between each of the dynamic pressure groove 91, 92, 93 and 94 and respective opposing surface.

The elements in which the dynamic pressure grooves 91,92,93 and 94 are formed, the first outer ring element 30, the second outer ring element 80 and the end plate element 20, are made from steel that can be hardened or stainless steel that can be hardened. The elements are heat treated and ground and then, by means of electrochemical machining the first dynamic pressure groove 91, the second dynamic pressure groove 92, the third dynamic pressure groove 93, and the fourth dynamic pressure groove 94 are formed in the elements.

Since the rest of the constitution does not differ from that of embodiment 5, a detailed explanation is omitted.

In the fluid dynamic bearing unit 1 of embodiment 6, constituted as mentioned above, the modularization of each element that constitutes it, namely, the case element 10, the end plate element 20, the first outer ring element 30, the second outer ring element 80, the flange-attached shaft element 40, and the spacer element 100 is easy, and by means of each element being modularized in this way, a standardized fluid dynamic bearing unit 1 is easily manufactured.

Furthermore, by changing the radial distance of the gap formed between the outer ring element 30 and the main body 41of the flange-attached shaft element 40, the dynamic pressure generated in this gap can be adjusted. Additionally, by changing the radial distance of the gap formed between the outer ring element 80 and the main body 41 of the flange-attached shaft element 40, the dynamic pressure generated in this gap can be adjusted. Thus, the dynamic pressure generated in these two gaps can be adjusted to suit the desired use conditions, i.e., the desired load in the radial direction.

Furthermore, in a fluid dynamic bearing unit 1 of the same height, by variously changing the axial direction height W1 of the first outer ring element 30 and the axial direction height W2 of the second outer ring element 80, the dynamic pressure that receives the load in the radial direction can be adjusted to suit a desired use condition. Also, by changing the radial distance of the gap formed by the first outer ring element 30 and the main body 41as well as the gap formed by the second outer ring element 80 and the main body 41, the dynamic pressure generated in these gaps can be adjusted to suit a desired use condition becomes possible. These two methods of adjusting dynamic pressure may be combined to suit a desired use condition.

Furthermore, by means of the spacer element 100, even when the flange part 42 is of differing thickness', the axial direction position of the first outer ring element 30 and the second outer ring element 80 can be accurately adjusted and set with respect to the end plate element 20.

Furthermore, the first outer ring element 30, the second outer ring element 80 and the end plate element 20 in which dynamic pressure grooves 91, 92, 93 and 94 are formed, are manufactured from steel that can be hardened or stainless steel that can be hardened, heat treated and ground. Then, dynamic pressure grooves are formed by electrochemical machining. Thus, these elements can be obtained with high hardness and high dimensional accuracy. Particularly, since dynamic pressure grooves of fine surface roughness can be obtained and the shape thereof is maintained, the dynamic pressure bearing function as designed can be exhibited. In addition, by means of electrochemical machining, the machining time for the purpose of dynamic pressure groove formation can be shortened. Besides, effects the same as in embodiment 5 can be produced.

Furthermore, in embodiment 6, the dynamic pressure grooves 91, 92, 93 and 94 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 91, 92, 93 and 94 are changed, the same effects as mentioned above can be produced.

### Embodiment 7

Next, embodiment 7 of the invention of this application will be explained.

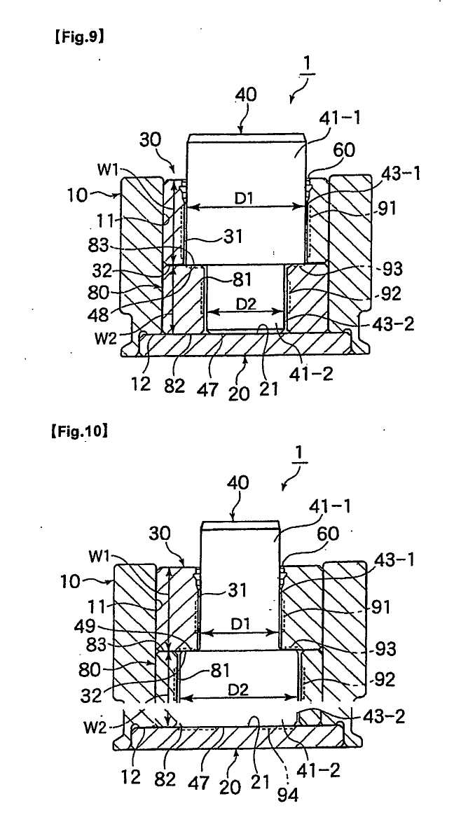

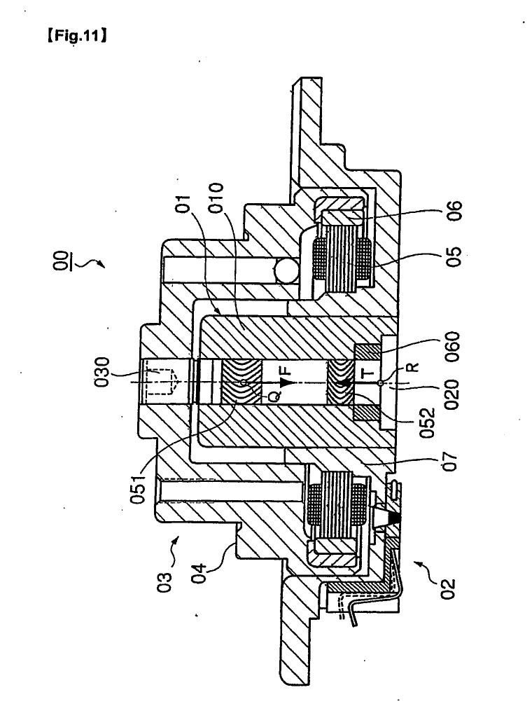

FIG. 8 is a cross-sectional view of a fluid dynamic bearing unit 1 of embodiment 7. As illustrated in the figure, the fluid dynamic bearing unit 1 of the seventh embodiment, when compared to the fluid dynamic bearing unit 1 (FIG. 4) of embodiment 4, differs in that an outer ring element 30 and a flange-attached outer ring element 70 in the fluid dynamic bearing unit 1 of embodiment 7 are divided in two parts.

Accordingly, the upper part of the outer ring element 30 is still called the first outer ring element 30, and an inner circumferential surface and a lower end surface thereof is still referred to with reference numerals 31 and 32. The lower part of the outer ring is newly regarded as a second outer ring element 80, and to an inner circumferential surface, a lower end surface and an upper end surface thereof, are referred to with numerals (reference numerals the same as embodiment 6 (FIG. 7)) 81, 82, and 83. The upper part of the flange-attached outer ring element 70 is still called a first inner ring element 70, and to an outer circumferential surface thereof, the same as in embodiment 4, reference numeral 73 is affixed. The lower end surface of first inner ring element 70 is referred to with reference numeral 76. The lower part is newly regarded as a second flange-attached outer ring element 110, and to a main part, a flange part, a outer circumferential surface, a upper surface of the flange part, a lower surface of the flange part, and a upper end part new reference numerals 111, 112, 113, 114, 115, 116 are, respectively, affixed. The other parts that correspond to embodiment 4 and have the same reference numerals are affixed to them.

The fluid dynamic bearing unit 1 of the seventh embodiment freely supports the relative rotation of a straight shaft element 40, and is provided with a case element 10, and an end plate element 20. The first outer ring element 30 and the second outer ring element 80 fit into the case element 10, and the first inner ring element 70 fit into the first outer ring element 30. The second flange-attached inner ring element 110, having a flange part 112, is sandwiched between the lower end surface 82 of the second outer ring element 80 and an upper surface 21 of the end plate element 20. The second flange-attached inner ring element 110 is inserted into the second outer ring element 80. The shaft element 40 is fit into the first outer ring element 70 and the second flange-attached inner ring element 110.

The dynamic pressure groove 91 is formed on the inner circumferential surface 31 of the first outer ring element 30. The dynamic pressure groove 91 generates dynamic pressure between the outer circumferential surface 73 and the inner circumferential surface 31. This dynamic pressure receives the load in the radial direction. The dynamic pressure groove 92 is formed on the inner circumferential surface 81 of the second outer ring element 80. The dynamic pressure groove 92 generates dynamic pressure between the outer circumferential surface 113 and the inner circumferential surface 81. This dynamic pressure also receives the load in the radial direction. The dynamic pressure groove 93 is formed on the lower end surface 82 of the second outer ring element 80. The dynamic pressure groove 93 generates dynamic pressure between an upper surface 114 of flange part 112 and the lower end surface 82. This dynamic pressure receives the load in the axial direction. The dynamic pressure groove 94 is formed on the upper surface 21 of the end plate element 20. The dynamic pressure groove 94 generates dynamic pressure between a lower surface 115 of flange part 112 and the upper surface 21. This dynamic pressure receives the load in the axial direction. Lubricating oil is filled into each of the minute gap formed between each of the dynamic pressure groove 91, 92, 93 and 94 and respective opposing surface.

The lower end surface 32 of the first outer ring element 30 and the upper end surface 83 of the second outer ring element 80 make contact, and the lower end surface 76 of the first inner ring element 70 contacts the upper end surface 116 of the second flange-attached inner ring element 110. The lower end surface 46 of the shaft element 40 slightly floats from the upper surface 21 of the end plate element 20.

The elements in which the dynamic pressure grooves are formed, in this embodiment 7, the first outer ring element 30, the second outer ring element 80 and the end plate element 20, are manufactured from steel that can be hardened or stainless steel that can be hardened, heat treated and ground. Then, by means of electrochemical machining, the first dynamic pressure groove 91, the second dynamic pressure groove 92, the third dynamic pressure groove 93 and the fourth dynamic pressure groove 94 are, respectively, formed. Furthermore, the first inner ring element 70 and the second flange-attached inner ring element 110 also can be manufactured from the same material.

Since the rest of the constitution does not differ from embodiment 4, a detailed explanation has been omitted.

In the fluid dynamic bearing 1 of the seventh embodiment, constituted as mentioned above, modularization of each element such as the case element 10, the end plate element 20, the fist outer ring element 30, the second outer ring element 80, the first inner ring element 70, the second flange-attached inner ring element 110, and the shaft element 40 is easy, and by means of each element being modularized in this way, a standardized fluid dynamic bearing unit is easily manufactured.

Furthermore, by changing the radial distance of the gap formed by the first outer ring element 30 and the first inner ring element 70, and the gap formed by the second outer ring element 80 and the main body 111 of the second flange-attached inner ring element 110 to different dimensions, the dynamic pressure subject to the load in the radial direction can be adjusted to suit the desired use conditions

Furthermore, in a fluid dynamic bearing unit 1 of the same height, by variously changing the axial direction height W1 of the first outer ring element 30 and the axial direction height W2 of the second outer ring element 80, and correspondingly variously changing the axial direction height of the first inner ring element 70 and the axial direction height of the second flange-attached inner ring element 110, and combining these change in axial dimensions with the adjusting of the dynamic pressure as described above, both the dynamic pressure generation position and the dynamic pressure can be adjusted to suit desired use conditions.

When the dynamic pressure and the dynamic pressure generation position are adjusted in this way, i.e., by having the gap radius formed by the first outer ring element 30 and the first inner ring element 70 (radius of a virtual cylindrical film which the gap center forms), and the gap radius formed by the second outer ring element 80 and the main body 111 of the second flange-attached inner ring element 110 differ, the degree of freedom of the adjustment of the above-mentioned dynamic pressure can be further widened. Furthermore, the inner diameter of the first inner ring element 70 and the inner diameter of the second flange-attached inner ring element can differ, and in line with this, the shaft element 40 can be have a stepped construction having a large diameter part and a small diameter part (refer to embodiments 8 and 9 described below). The shaft element with multiple steps can also be considered. By such diverse combinations diverse adjustment of the dynamic pressure and the dynamic pressure generation position is possible. Due to this, prompt response to the design requirements of the bearing that is optimum for diverse load states becomes possible.

The dynamic pressure grooves 91, 92, 93 and 94 and the elements in which the dynamic pressure grooves 91, 92, 93 and 94 are formed, in embodiment 7, are manufactured as previously disclosed in the context of first embodiment, and have the same properties and advantages. In addition, effects the same as embodiment 4 can be produced.

Furthermore, as in embodiment 4, the dynamic pressure grooves 91, 92, 93 and 94 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 91, 92, 93 and 94 are changed, the same effects as mentioned above can be produced

### Embodiment 8

Next, embodiment 8 of the invention of this application will be explained.

FIG. 9 is a cross-sectional view of a fluid dynamic bearing unit 1 of embodiment 8. The fluid dynamic bearing unit 1 of embodiment 8 can be thought of as the fluid dynamic bearing unit 1 of embodiment 5 (FIG. 6) in which the flange part 42 of the flange-attached shaft element 40 has been cut out. Accordingly, the same reference numeral 40 is affixed to the new stepped shaft element formed with the flange part 42 cut out. The upper half (large diameter part), the lower half (small diameter part), the downward facing surface of the step part thereof, are referred to with the new reference numerals 41-1, 41-2, 48 respectively. To the other parts that correspond to the embodiment 5 (FIG. 6) the same reference numerals are affixed.

The fluid dynamic bearing unit 1 of embodiment 8 freely supports the relative rotation of a stepped shaft element 40 having an upper half large diameter part 41-1 and a lower half small diameter part 41-2. The fluid dynamic bearing unit 1 is provided with a tubular case element 10 having a cylindrical shaped inner circumferential surface 11, and an end plate element 20 that closes the lower end part of the case element 10. The fluid dynamic bearing also includes the first outer ring element 30 having a cylindrical shaped inner circumferential surface 31 of a large diameter and a second outer ring element 80 having a cylindrical shaped inner circumferential surface 81 of a small diameter, and the stepped shaft element 40 is inserted into a first outer ring element 30 and a second outer ring element 80 so that the large diameter part 41-1 thereof inserted into the first outer ring element 30 and the small diameter part thereof 41-2 inserted into the second outer ring element 80.

The dynamic pressure groove 91 is formed on the inner circumferential surface 31 of the first outer ring element 30. The dynamic pressure groove 91 generates dynamic pressure between the outer circumferential surface 43-1 of the large diameter part 41-1 of the stepped shaft element 40 and the inner circumferential surface 31. This dynamic pressure receives the load in the radial direction. The dynamic pressure groove 92 is formed on the inner circumferential surface 81 of the second outer ring element 80. The dynamic pressure groove 92 generates dynamic pressure between the opposing outer circumferential surface 43-2 of the small diameter part 41-2 of the stepped shaft element 40 and the inner circumferential surface 81. This dynamic pressure also receives the load in the radial direction. The dynamic pressure groove 93 is formed on the upper end surface 83 of the second outer ring element 80. The dynamic pressure groove 93 generates dynamic pressure between the opposing surface of the step part 42 of the stepped shaft element 40 and the lower end surface 82. This dynamic pressure receives the load in the axial direction. Lubricating oil is filled into each of the minute gap formed between each of the dynamic pressure groove 91, 92, and 93 and respective opposing surface.

The lower end surface 32 of the first outer ring element 30 and the upper end surface 83 of the second outer ring element 80 (the part further to the outside from the part which the third dynamic pressure groove 93 forms) are in contact, and the lower end surface 82 of the second outer ring element 80 and the upper surface 21 of the end plate element 20 are in contact. The lower end surface 47 of the stepped shaft element 40 is floated slightly from the upper surface 21 of the end plate element 20.

The elements in which the dynamic pressure grooves are formed in embodiment 8, the first outer ring element 30 and the second outer ring element 80, are manufactured from steel that can be hardened or stainless steel that can be hardened, heat treated and ground. Then, by means of electrochemical machining, the first dynamic pressure groove 91, the second dynamic pressure groove 92 and the third dynamic pressure groove 93 are, respectively, formed. Furthermore, it is also acceptable to manufacture the stepped shaft element 40 from the same material, carry out heat treatment in the same way, and finish with grinding.

Since the rest of the constitution does not differ from the variation example (FIG. 6) of embodiment 5, a detailed explanation is omitted.

In the fluid dynamic bearing unit 1 of the eighth embodiment, constituted as mentioned above, modularization of each element that constitutes it, namely, the case element 10, the end plate element 20, the first outer ring element 30, the second outer ring element 80, and the stepped shaft element 40, is easy. With each element modularized in this way a standardized fluid dynamic bearing unit 1 can be easily manufactured.

Furthermore, by changing the outer diameter dimension D1 of the large diameter part 41-1 and the outer diameter dimension D2 of the small diameter part 41-2 of the stepped shaft 40 and correspondingly changing the inside diameter of the first outer ring element 30 and the second outer ring element 80 it is possible to adjust the dynamic pressure subject to the load in the radial direction to suit the desired use conditions.

Furthermore, in a fluid dynamic bearing unit 1 of the same height, by variously changing the ratio of the axial direction dimension of the large diameter part 41-1, and the axial direction dimension of the small diameter part 41-2, of the stepped shaft element 40, and in response thereto variously changing and combining the axial direction height W1 of the first outer ring element 30 and the axial direction height W2 of the second outer ring element 80, it is possible to adjust the dynamic pressure that receives the load of the radial direction and the dynamic pressure generation position to suit a desired use condition.

Furthermore, since the axial direction height W2 of the second outer ring element 80 and the axial position of the step part of the stepped shaft element 40 can be adjusted, the position of a dynamic pressure generation part formed in the minute gap between the facing surface of stepped shaft 40 and outer ring element 80 can be adjusted to suit the center of gravity of the entire rotating body in the axial direction. Thereby, the movement that acts in the direction that knocks down the stepped shaft element can be reduced and the whirling vibration attributable to the gyroscopic movement of the stepped shaft element 40 is lowered. The relative rotation of the stepped shaft 40 is stabilized causing the improvement of rotational accuracy.

Furthermore, due to the fact that the outer end part of the stepped shaft element 40 is connected to the load member of the rotor hub and the like, a comparatively high bearing rigidity is necessary. On the large diameter part 41-1 side of the stepped shaft element 40 positioned on the opposite side of the side which the case element 10 has closed by the end plate element 20, the radial dynamic pressure bearing part of the large diameter having comparatively low bearing rigidity is set. The small diameter part 41-2 side of the stepped shaft element 40 is positioned on the side on which the case element 10 has been closed by the end plate element 20. Since friction loss is proportional to the third power of the bearing diameter, the radial dynamic pressure bearing part having this small diameter can reduce friction loss and so, when viewed as a whole, by means of a simple constitution, while ensuring the necessary bearing rigidity, bearing failure torque is reduced as much as possible and power consumption is also reduced.

In addition, due to the fact that friction loss can be reduced in the small diameter radial dynamic pressure bearing part, the movement that acts in the direction that knocks down the stepped shaft element 40 can be reduced. Because of this aspect also, the whirling vibration attributable to the gyroscopic movement of the stepped shaft element is reduced, the relative rotation thereof is stabilized, and the rotational accuracy is improved.

Furthermore, the first outer ring element 30 and the second outer ring element 80 that are the elements in which dynamic pressure grooves 91, 92 and 93 are formed are manufactured from steel that can be hardened or stainless steel that can be hardened, heat treated and ground. Then, by means of electrochemical machining, these dynamic pressure grooves 91, 92 and 93 are finished, and so, these elements can be obtained with high hardness and high dimensional accuracy. They are difficult to damage and a high dimensional accuracy can be maintained. Particularly, since dynamic pressure grooves of fine surface roughness can be obtained and the shape thereof is maintained, the dynamic pressure bearing function as designed can be exhibited. In addition, by means of electrochemical machining, the machining time for the purpose of dynamic pressure groove formation can be shortened.

In addition, this embodiment 8 can produce the same effects as the variation example (FIG. 6) of embodiment 5. However, the fluid dynamic bearing unit 1 of embodiment 8 is suitable for use when the action that constantly presses the shaft element 40 towards the end plate element 20 due to the bias effect of magnetic force and the like that works between a rotating side element and a stationary side element is present. On this point the action and effect of the eighth embodiment are different from that of the fifth embodiment (FIG. 6).

Furthermore, as in embodiment 1, the dynamic pressure grooves 91, 92 and 93 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 91, 92 and 93 are changed, the same effects as mentioned above can be produced.

### Embodiment 9

Next, embodiment 9 of the invention of this application will be explained

FIG. 10 is a cross-sectional view of a fluid dynamic bearing unit 1 of embodiment 9. In the fluid dynamic bearing unit 1 of embodiment 9 the large and small diameter of the upper half part and the lower half part of the stepped shaft 40 of the eighth embodiment are reversed. Consequently, in embodiment 9, a small diameter part 41-1 forms the upper half and a large diameter part 41-2 forms the lower half. Furthermore, in line with this, the inner circumferential surface diameter of a first outer ring element 30 is small and each the inner circumferential surface diameter of and a second outer ring element 80 is large. A step surface 49 is formed at the step part of a stepped shaft element 40 and is facing upwards. The same reference numerals are affixed to the other parts that correspond to embodiment 8.

The fluid dynamic bearing unit 1 of embodiment 9 freely supports the rotation of the stepped shaft element 40 having the small diameter 41-1 upper half and the large diameter 41-2 lower half. The fluid dynamic bearing unit 1 of embodiment 9 includes a tubular case element 10 having a cylindrical shaped inner circumferential surface 11, and an end plate element 20 that closes the lower end part of the case element 10. The fluid dynamic bearing unit 1 also includes the first outer ring element 30 having a cylindrical shaped inner circumferential surface 31 of a small diameter and the second outer ring element 80 having a cylindrical shaped inner circumferential surface 81 of a large diameter fit into a case element 10. The stepped shaft element 40 is inserted into the first outer ring element 30 and the second outer ring element 80. The small diameter part 41-1 of the shaft element 40 is inserted into the first outer ring element 30 and the large diameter part 41-2 thereof is inserted into the second outer ring element 80.

A dynamic pressure groove 91 is formed on the inner circumferential surface 31 of the first outer ring element 30. The dynamic pressure groove 91 generates dynamic pressure between the outer circumferential surface 43-1 of the small diameter part 41-1 of the stepped shaft element 40 and the inner circumferential surface 31. This dynamic pressure receives the load in the radial direction. A dynamic pressure groove 92 is formed on the inner circumferential surface 81 of the second outer ring element 80. The dynamic pressure groove 92 generates dynamic pressure between the opposing outer circumferential surface 43-2 of the large diameter part 41-2 of the stepped shaft element 40 and the inner circumferential surface 81. This dynamic pressure also receives the load in the radial direction. A dynamic pressure groove 93 is formed on a lower end surface 32 of the first outer ring element 30. The dynamic pressure groove 93 generates dynamic pressure between the opposing surface of the step part 42 of the stepped shaft element 40 and the lower end surface 32. The dynamic pressure groove 94 is formed on an upper surface 21 of the end plate element 20. A dynamic pressure groove 94 generates dynamic pressure between an opposing lower end surface 47 of the stepped shaft element 40 and the upper surface 21. This dynamic pressure receives the load in the axial direction. Lubricating oil is filled into each of the minute gap formed between each of the dynamic pressure groove 91, 92, 93 and 94 and respective opposing surface.

The lower end surface 32 of the first outer ring element 30 and an upper end surface 83 of the second outer ring element 80 make contact, and a lower end surface 82 of the outer ring element 80 and the upper surface 21 of the end plate element 20 make contact.

The elements in which the dynamic pressure grooves are formed, the first outer ring element 30, the second outer ring element 80 and the end plate element 20, are manufactured from steel that can be hardened or stainless steel that can be hardened, heat treated and ground. Then, by means of electrochemical machining, the first dynamic pressure groove 91, the second dynamic pressure groove 92, the third dynamic pressure groove 93 and the fourth dynamic pressure groove 94 are formed. Furthermore, manufacturing the stepped shaft element 40 from the same material, performing the same heat treatment and the grinding is also acceptable.

Since the rest of the constitution does not differ from embodiment 8, a detailed explanation has been omitted.

In the fluid dynamic bearing unit 1 of embodiment 9, constituted as mentioned above, modularization of each element such as the case element 10, the end plate element 20, the first outer ring element 30, the second outer ring element 80 and the stepped shaft element 40 is easy, and with each element modularized in this way, standardized fluid dynamic bearing unit 1 is easily manufactured.

Furthermore, by changing the outer diameter dimension D1 of the small diameter part 41-1 and the outer diameter dimension D2 of the large diameter part 41-2 of the stepped shaft element 40 and correspondingly changing the inside diameter of the first outer ring element 30 and the second outer ring element 80 it is possible to adjust the dynamic pressure subject to the load in the radial direction to suit the desired use conditions.

Furthermore, in a fluid dynamic bearing unit 1 of the same height, by variously changing the ratio of the axial direction dimension of the small diameter part 41-1, and the axial direction dimension of the large diameter part 41-2, of the stepped shaft element 40, and in response thereto variously changing and combining the axial direction height W1 of the first outer ring element 30 and the axial direction height W2 of the second outer ring element 80, it is possible to adjust the dynamic pressure that receives the load of the radial direction and the dynamic pressure generation position to suit a desired use condition.

Furthermore, since the axial direction height W1 of the axial direction height of the first outer ring element 30 and the axial position of the step part of the stepped shaft element 40 can be adjusted, the position of a dynamic pressure generation part formed in the minute gap between the facing surface of stepped shaft 40 and first outer ring element 30 can be adjusted to suit the center of gravity of the entire rotating body in the axial direction Thereby, the movement that acts in the direction that knocks down the stepped shaft element can be reduced and the whirling vibration attributable to the gyroscopic :movement of the stepped shaft element 40 is lowered. The relative rotation of the stepped shaft 40 is stabilized causing the improvement of rotational accuracy.

Furthermore, the small diameter of the radial dynamic pressure bearing part reduces friction loss, which in turn reduces bearing failure torque, which in turn can reduce power consumption.

In addition, due to the fact that friction loss can be reduced in the small diameter radial dynamic pressure bearing part, the movement that acts in the direction that knocks down the stepped shaft element 40 can be reduced. Because of this aspect, the whirling vibration attributable to the gyroscopic movement of the stepped shaft element is reduced, the relative rotation thereof is stabilized, and the rotational accuracy is improved.

Furthermore, the first outer ring element 30 and the second outer ring element 80 and the end plate element 20 that are the elements in which dynamic pressure grooves 91, 92, 93 and 94 are formed are manufactured from steel that can be hardened or stainless steel that can be hardened, heat treated and ground. Then, by means of electrochemical machining, these dynamic pressure grooves 91, 92, 93 and 94 are finished, and so, these elements can be obtained with high hardness and high dimensional accuracy. They are difficult to damage and a high dimensional accuracy can be maintained. Particularly, since dynamic pressure grooves of fine surface roughness can be obtained and the shape thereof is maintained, the dynamic pressure bearing function as designed can be exhibited. In addition, by means of electrochemical machining, the machining time for the purpose of dynamic pressure groove formation can be shortened.

The dynamic pressure that is generated in the third dynamic pressure groove 93 and the fourth dynamic pressure groove 94 maintains the appropriate clearance between the opposing surface of the step part 42 of the stepped shaft element 40 and the lower end surface 32, and between the opposing lower end surface 47 of the stepped shaft element 40 and the upper surface 21. This effect of the dynamic pressure is similar to an action in which the stepped shaft element 40 is constantly being pressed in an axial direction towards an endplate element 20 by means of a bias effect such as a magnetic force that works between a rotating side element and a fixed side element. The effect of the dynamic pressure is to stabilize the relative rotation of the stepped shaft element 40 and improve rotation accuracy. In addition, the same effects as in embodiment 8 can be produced.

Furthermore, as in embodiment 1, the dynamic pressure grooves 91, 92, 93 and 94 can be formed on the complimentary surface. In this case also, elements in which dynamic pressure grooves are formed are manufactured from steel that can be hardened or stainless steel that can be hardened, and after being heat-treated and ground, the dynamic pressure grooves thereof are formed by electrochemical machining. Even when the locations of the dynamic pressure grooves 91, 92, 93 and 94 are changed, the same effects as mentioned above can be produced.

The invention of this application is not limited to the working examples above. In a range in which the essentials there do not change, various variations are possible. For example, in embodiments 8 and 9 the step part (the part that shifts from a large diameter part to a small diameter part) of the stepped shaft element 40 can also be made a tapered shape. While preferred embodiments of the invention has been described, various modifications will be apparent to one skilled in the art in light of this disclosure and are intended to fall within the scope of the appended claims.

We claim:

1. A fluid dynamic bearing unit composed of a plurality of modularized elements, the fluid dynamic bearing unit comprising:
a tubular case element having a cylindrical shaped inner circumferential surface;
an end plate element closing a lower end of the tubular case element;
an outer ring element fitted into the tubular case element;
a flange-attached shaft element inserted into the outer ring element in such a way that the flange part thereof is located between a lower end surface of the outer ring element and an upper surface of the end plate element;
at least one first dynamic pressure groove formed on an inner circumferential surface of the outer ring element or an outer circumferential surface of the main body of the flange-attached shaft element;
a second dynamic pressure groove formed on the lower end surface of the outer ring element or an upper surface of the flange part of the flange-attached shaft element;
a third dynamic pressure groove formed on the upper surface of the end plate element or a lower surface of the flange part of the flange-attached shaft element; and
lubricating oil filled in the minute gap between each of the facing surfaces corresponding to the first dynamic pressure groove, the second dynamic pressure groove, and the third dynamic pressure groove.

2. The fluid dynamic bearing of claim 1 having two first dynamic pressure grooves that are spaced apart in the direction of the axis of rotation of the fluid dynamic bearing.

3. The fluid dynamic bearing unit of claim 1, wherein the elements in which the first, second and third dynamic pressure grooves are formed are made of steel that can be hardened or stainless steel that can be hardened and these elements are hardened, ground and then the first, second and third dynamic pressure grooves are formed in the elements.

4. The fluid dynamic bearing unit of claim 1, wherein the tubular case element further comprises a step part formed in the lower end part of the tubular case element, the step part being finished at the same time as the inner circumferential surface of the tubular case element and the end~plate element being fitted in the step part, thereby closing the lower end part of the tubular case element.

5. The fluid dynamic bearing unit of claim 1, wherein a bearing container is formed by integrating the tubular case element and the end plate element.

6. The fluid dynamic bearing unit of claim 1, further comprising a lubricating oil seal.

7. The fluid dynamic bearing unit of claim 1, wherein the end plate element is coated with Diamond-Like Carbon.

8. A fluid dynamic bearing unit composed of a plurality of modularized elements, the fluid dynamic bearing unit comprising:
a tubular case element having a cylindrical shaped inner circumferential surface;
an end plate element closing a lower end of the tubular case element;
an outer ring element fitted into the tubular case element; and
a shaft element inserted into the outer ring element;
at least one first dynamic pressure groove formed on an inner circumferential surface of the outer ring element or an outer circumferential surface of the shaft element;
a second dynamic pressure groove is formed -on an upper surface of the end plate element or a lower surface of the shaft element; and
lubricating oil filled in the minute gap between each of the facing surfaces corresponding to the first dynamic pressure groove and the second dynamic pressure groove.

9. The fluid dynamic bearing of claim 8 having two first dynamic pressure grooves that are spaced apart in the direction of the axis of rotation of the fluid dynamic bearing.

10. The fluid dynamic bearing unit of claim 8, wherein the elements in which the first and second dynamic pressure grooves are formed are made of steel that can be hardened or stainless steel that can be hardened and these elements are hardened, ground and then the first and second dynamic pressure grooves are formed in the elements.

11. The fluid dynamic bearing unit of claim 8, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

12. The fluid dynamic bearing unit of claim 8, wherein a bearing container is formed by integrating the tubular case element and the end plate element.

13. The fluid dynamic bearing unit of claim 8, further comprising a lubricating oil seal.

14. The fluid dynamic bearing unit of claim 8, wherein the end plate element is coated with Diamond-Like Carbon.

15. A fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
an outer ring element fitted into the tubular case element;
an inner ring element inserted into the outer ring element; and
a flange-attached shaft element fitted into the inner ring element in such a way that the flange part thereof has a lower end surface of the outer ring element as well as a lower end surface of the inner ring element on one side and an upper surface of the end plate element on the opposite side;
at least one first dynamic pressure groove formed on an inner circumferential surface of the outer ring element or an outer circumferential surface of the inner ring element;
a second dynamic pressure groove formed on a lower end surface of the outer ring element or an upper surface of the flange part thereof;
a third dynamic pressure groove formed on an upper surface of the end plate element or a lower surface of the flange part of the flange-attached shaft element; and
lubricating oil filled in the minute gap between each of the facing surfaces corresponding to the first dynamic pressure groove, the second dynamic pressure groove, and the third dynamic pressure groove.

16. The fluid dynamic bearing of claim 15 having two first dynamic pressure grooves that are spaced apart in the direction of the axis of rotation of the fluid dynamic bearing.

17. The fluid dynamic bearing unit of claim 15, wherein the elements in which the first, second and third dynamic pressure grooves are formed are made of steel that can be hardened or stainless steel that can be hardened and these elements are hardened, ground and then the first, second and third dynamic pressure grooves are formed in the elements.

18. The fluid dynamic bearing unit of claim 15, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

19. The fluid dynamic bearing unit of claim 15, wherein a bearing container is formed by integrating the tubular case element and the end plate element.

20. The fluid dynamic bearing unit of claim 15, further comprising a lubricating oil seal.

21. The fluid dynamic bearing unit of claim 15, wherein the end plate element is coated with Diamond-Like Carbon.

22. A fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
an outer ring element fitted into the tubular case element;
a flange-attached inner ring element having a flange part at one end inserted into the outer ring element in such a way that the flange part of the flange-attached inner ring element is located between a lower end surface of the outer ring element and an upper surface of the end plate element;
a shaft element fitted into the flange-attached inner ring element;
at least one first dynamic pressure groove formed on an inner circumferential surface of the outer ring element or an outer circumferential surface of the main body of the flange-attached inner ring element;
a second dynamic pressure groove is formed on a lower end surface of the outer ring element or an upper surface of the flange part of the flange-attached inner ring element;
a third dynamic pressure groove is formed on an upper surface of the end plate element or a lower surface of the flange part of the flange-attached inner ring element; and
lubricating oil filled in the minute gap between each of the facing surfaces corresponding to the first dynamic pressure groove, the second dynamic pressure groove, as well as the third dynamic pressure groove.

23. The fluid dynamic bearing of claim 22 having two first dynamic pressure grooves that are spaced apart in the direction of the axis of rotation of the fluid dynamic bearing.

24. The fluid dynamic bearing unit of claim 22, wherein the elements in which the first, second and third dynamic pressure grooves are formed are made of steel that can be hardened or stainless steel that can be hardened and these elements are hardened, ground and then the first, second and third dynamic pressure grooves are formed in the elements.

25. The fluid dynamic bearing unit of claim 22, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

26. The fluid dynamic bearing unit of claim 22, wherein a bearing container is formed by integrating the tubular case element and the end plate element.

27. The fluid dynamic bearing unit of claim 22, further comprising a lubricating oil seal.

28. The fluid dynamic bearing unit of claim 22, wherein the end plate element is coated with Diamond-Like Carbon.

29. A fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element fitted into the tubular case element;
a second outer ring element fitted into the tubular case element;
a flange-attached shaft element having a main body and a flange part inserted into the first outer ring element as well as the second outer ring element in a way such that the flange part thereof is located between a lower end surface of the first outer ring element and an upper surface of the second outer ring element;
a first dynamic pressure groove is formed on an inner circumferential surface of the first outer ring element or an outer circumferential surface of the main body of the flange-attached shaft element;
a second dynamic pressure groove is formed on an inner circumferential surface of the second outer ring element or an outer circumferential surface of the main body of the flange-attached shaft element;
a third dynamic pressure groove is formed on a lower surface of the first outer ring element or an upper surface of the flange part of the flange-attached shaft element;
a fourth dynamic pressure groove is formed on an upper surface of the second outer ring element or a lower surface of the flange part of the flange-attached shaft element; and
lubricating oil filled in the minute gap between each of the facing surfaces corresponding to the first dynamic pressure groove, the second dynamic pressure groove, the third dynamic pressure groove and the fourth dynamic pressure groove.

30. A fluid dynamic bearing unit of claim 29, wherein
the main body of the flange-attached shaft element has two sections, each section having a different diameter.

31. The fluid dynamic bearing unit of claim 29, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

32. The fluid dynamic bearing unit of claim 29, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

33. The fluid dynamic bearing unit of claim 29, wherein a bearing container is formed by integrating the tubular case element and the end plate element.

34. The fluid dynamic bearing unit of claim 29, further comprising a lubricating oil seal.

35. The fluid dynamic bearing unit of claim 29, wherein the end plate element is coated with Diamond-Like Carbon.

36. A fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element fitted into the tubular case element;
a second outer ring element fitted into the tubular case element;
a flange-attached shaft element having a main body and a flange part inserted into the first outer ring element as well as the second outer ring element in such a way that the flange part thereof is located between a lower end surface of the second outer ring element and an upper surface of the end plate element;
a spacer element surrounding the flange part of the flange-attached shaft element for positioning the second outer ring element relative to the end plate element;
a first dynamic pressure groove formed on an inner circumferential surface of the first outer ring element or an outer circumferential surface of the main body of the flange-attached shaft element;
a second dynamic pressure groove formed on an inner circumferential surface of the second outer ring element or an outer circumferential surface of the main body of the flange-attached shaft element;
a third dynamic pressure groove formed on a lower surface of the second outer ring element or an upper surface of the flange part of the flange-attached shaft element;
a fourth dynamic pressure groove is formed on an upper surface of the end plate element or a lower surface of the flange part of the flange-attached shaft element; and
lubricating oil filled in the minute gap between each of the facing surfaces corresponding to the first dynamic pressure groove, the second dynamic pressure groove, the third dynamic pressure groove and the fourth dynamic pressure groove.

37. A fluid dynamic bearing unit of claim 36, wherein
the main body of the flange-attached shaft element has two sections, each section having a different diameter.

38. The fluid dynamic bearing unit of claim 36, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

39. The fluid dynamic bearing unit of claim 36, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

40. The fluid dynamic bearing unit of claim 36, wherein a bearing container is formed by integrating the tubular case element and the end plate element.

41. The fluid dynamic bearing unit of claim 36, further comprising a lubricating oil seal.

42. The fluid dynamic bearing unit of claim 36, wherein the end plate element is coated with Diamond-Like Carbon.

43. A fluid dynamic bearing unit composed of a plurality of a modularized elements, the fluid dynamic bearing unit comprising:
a tubular case element having a cylindrical shaped inner circumferential surface;
an end plate element closing the lower end part of the tubular case element;
a first outer ring element fitted into the tubular case element;
a second outer ring element fitted into the tubular case element;
a first inner ring element inserted into the first outer ring element;
a second flange-attached inner ring element having a flange part at one end, inserted into the second outer ring element in such a way that the flange part is located between the lower end surface of the second outer ring element and the upper surface of the end plate element;
a shaft element fitted into the first inner ring element as well as the second inner ring element;
a first dynamic pressure groove formed on an inner circumferential surface of the first outer ring element or an outer circumferential surface of the first inner ring element;
a second dynamic pressure groove formed on an inner circumferential surface of the second outer ring element or an outer circumferential surface of the second flange-attached inner ring element;
a third dynamic pressure groove formed on a lower surface of the second outer ring element or an upper surface of the flange part of the second flange-attached inner ring element;
a fourth dynamic pressure groove is formed on an upper surface of the end plate element or a lower surface of the flange part of the second flange-attached inner ring element; and
lubricating oil filled in the minute gap between each of the facing surfaces corresponding to the first dynamic pressure groove, the second dynamic pressure groove, the third dynamic pressure groove and the fourth dynamic pressure groove.

44. The fluid dynamic bearing unit of claim 43, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

45. The fluid dynamic bearing unit of claim 43, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

46. The fluid dynamic bearing unit of claim 43, wherein a bearing container is formed by integrating the tubular case element and the end plate element.

47. The fluid dynamic bearing unit of claim 43, further comprising a lubricating oil seal.

48. The fluid dynamic bearing unit of claim 43, wherein the end plate element is coated with Diamond-Like Carbon.

49. A fluid dynamic bearing unit composed of a plurality of a modularized elements, the fluid dynamic bearing unit comprising:
a tubular case element having a cylindrical shaped inner circumferential surface;
an end plate element closing the lower end part of the tubular case element;
a first outer ring element having a large diameter fitted into the tubular case element;
a second outer ring element having a small diameter fitted into the tubular case element;
a stepped shaft element inserted into the first outer ring element as well as the second outer ring element in such a way that a large diameter part of the stepped shaft element is inserted into the first outer ring element and a small diameter part of the stepped shaft element is inserted into the second outer ring element;
a first dynamic pressure groove is formed on an inner circumferential surface of the first outer ring element or an outer circumferential surface of the large diameter part of the stepped shaft element;
a second dynamic pressure groove is formed on an inner circumferential surface of the second outer ring element or an outer circumferential surface of the small diameter part of the stepped shaft element;
a third dynamic pressure groove is formed on an upper surface of the second outer ring element or a surface of the step part of the stepped shaft element; and
lubricating oil is filled in the minute gap between each of the facing surfaces corresponding to the first dynamic pressure groove, the second dynamic pressure groove and the third dynamic pressure groove.

50. The fluid dynamic bearing unit of claim 49, wherein the elements in which the first, second and third dynamic pressure grooves are formed are made of steel that can be hardened or stainless steel that can be hardened and these elements are hardened, ground and then the first, second and third dynamic pressure grooves are formed in the elements.

51. The fluid dynamic bearing unit of claim 49, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

52. The fluid dynamic bearing unit of claim 49, wherein a bearing container is formed by integrating the tubular case element and the end plate element.

53. The fluid dynamic bearing unit of claim 49, further comprising a lubricating oil seal.

54. The fluid dynamic bearing unit of claim49, wherein the end plate element is coated with Diamond-Like Carbon.

55. A fluid dynamic bearing unit composed of a plurality of a modularized elements, the fluid dynamic bearing unit comprising:
a tubular case element having a cylindrical shaped inner circumferential surface;
an end plate element closing the lower end part of the tubular case element;
a first outer ring element having a small diameter fitted into the tubular case element;
a second outer ring element having a large diameter fitted into the tubular case element;
a stepped shaft element inserted into the first outer ring element as well as the second outer ring element in such a way that a small diameter part of the stepped shaft element is inserted into the first outer ring element and a large diameter part of the stepped shaft element is inserted into the second outer ring element;
a first dynamic pressure groove formed on an inner circumferential surface of the first outer ring element or an outer circumferential surface of the small diameter part of the stepped shaft element;
a second dynamic pressure groove is formed on an inner circumferential surface of the second outer ring element or an outer circumferential surface of the large diameter part of the stepped shaft element;
a third dynamic pressure groove is formed on a lower end surface of the first outer ring element or a surface of the step part of the stepped shaft element;
a fourth dynamic pressure groove is formed on an upper surface of the end plate element or a lower end surface of the stepped shaft element; and
lubricating oil is filled in the minute gap between each of the facing surfaces corresponding to the first dynamic pressure groove, the second dynamic pressure groove, the third dynamic pressure groove and the fourth dynamic pressure groove.

56. The fluid dynamic bearing unit of claim 55, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

57. The fluid dynamic bearing unit of claim 55, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

58. The fluid dynamic bearing unit of claim 55, wherein a bearing container is formed by integrating the tubular case element and the end plate element.

59. The fluid dynamic bearing unit of claim 55, further comprising a lubricating oil seal.

60. The fluid dynamic bearing unit of claim 55, wherein the end plate element is coated with Diamond-Like Carbon.

61. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing a lower end of the tubular case element;
an outer ring element fitted into the tubular case element;
a flange-attached shaft element inserted into the outer ring element in such a way that the flange part thereof is located between a lower end surface of the outer ring element and an upper surface of the end plate element;
at least one first dynamic pressure groove formed on an inner circumferential surface of the outer ring element or an outer circumferential surface of the main body of the flange-attached shaft element;
a second dynamic pressure groove formed on the lower end surface of the outer ring element or an upper surface of the flange part of the flange-attached shaft element;
a third dynamic pressure groove formed on the upper surface of the end plate element or a lower surface of the flange part of the flange-attached shaft element; and
lubricating oil filled in the minute gap between each of the facing surfaces corresponding to the first dynamic pressure groove, the second dynamic pressure groove, and the third dynamic pressure groove.

62. The hard disk drive device of claim 61 wherein the disk is chosen from a group consisting of a magnetic disk and an optical disk.

63. The hard disk drive device of claim 62 having two first dynamic pressure grooves that are spaced apart in the direction of the axis of rotation of the fluid dynamic bearing.

64. The hard disk drive device of claim 62, wherein the elements in which the first, second and third dynamic pressure grooves are formed are made of steel that can be hardened or stainless steel that can be hardened and these elements are hardened, ground and then the first, second and third dynamic pressure grooves are formed in the elements.

65. The hard disk drive device of claim 62, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

66. The hard disk drive device of claim 62, wherein a bearing container is formed by integrating the tubular case element and the end plate element.

67. The hard disk drive device of claim 62, further comprising a lubricating oil seal.

68. The hard disk drive device of claim 62, wherein the end plate element is coated with Diamond-Like Carbon.

69. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing a lower end of the tubular case element;
an outer ring element fitted into the tubular case element; and
a shaft element inserted into the outer ring element;
at least one first dynamic pressure groove formed on an inner circumferential surface of the outer ring element or an outer circumferential surface of the shaft element;
a second dynamic pressure groove is formed on an upper surface of the end plate element or a lower surface of the shaft element; and
lubricating oil filled in the minute gap between each of the facing surfaces corresponding to the first dynamic pressure groove and the second dynamic pressure groove.

70. The hard disk drive device of claim 69 wherein the disk is chosen from a group consisting of a magnetic disk and an optical disk.

71. The hard disk drive device of claim 70 having two first dynamic pressure grooves that are spaced apart in the direction of the axis of rotation of the fluid dynamic bearing.

72. The hard disk drive device of claim 70, wherein the elements in which the first and second dynamic pressure grooves are formed are made of steel that can be hardened or stainless steel that can be hardened and these elements are hardened, ground and then the first and second dynamic pressure grooves are formed in the elements.

73. The hard disk drive device of claim 70, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

74. The hard disk drive device of claim 70, wherein a bearing container is formed by integrating the tubular case element and the end plate element.

75. The hard disk drive device of claim 70, further comprising a lubricating oil seal.

76. The hard disk drive device of claim 70, wherein the end plate element is coated with Diamond-Like Carbon.

77. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
an outer ring element fitted into the tubular case element;
an inner ring element inserted into the outer ring element; and
a flange-attached shaft element fitted into the inner ring element in such a way that the flange part thereof has a lower end surface of the outer ring element as well as a lower end surface of the inner ring element on one side and an upper surface of the end plate element on the opposite side;
at least one first dynamic pressure groove formed on an inner circumferential surface of the outer ring element or an outer circumferential surface of the inner ring element;
a second dynamic pressure groove formed on a lower end surface of the outer ring element or an upper surface of the flange part thereof;
a third dynamic pressure groove formed on an upper surface of the end plate element or a lower surface of the flange part of the flange-attached shaft element; and
lubricating oil filled in the minute gap between each of the facing surfaces corresponding to the first dynamic pressure groove, the second dynamic pressure groove, and the third dynamic pressure groove.

78. The hard disk drive device of claim 77 wherein the disk is chosen from a group consisting of a magnetic disk and an optical disk.

79. The hard disk drive device of claim 78 having two first dynamic pressure grooves that are spaced apart in the direction of the axis of rotation of the fluid dynamic bearing.

80. The hard disk drive device of claim 78, wherein the elements in which the first, second and third dynamic pressure grooves are formed are made of steel that can be hardened or stainless steel that can be hardened and these elements are hardened, ground and then the first, second and third dynamic pressure grooves are formed in the elements.

81. The hard disk drive device of claim 78, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

82. The hard disk drive device of claim 78, wherein a bearing container is formed by integrating the tubular case element and the end plate element.

83. The hard disk drive device of claim 78, further comprising a lubricating oil seal.

84. The hard disk drive device of claim 78, wherein the end plate element is coated with Diamond-Like Carbon.

85. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
an outer ring element fitted into the tubular case element;
a flange-attached inner ring element having a flange part at one end inserted into the outer ring element in such a way that the flange part of the flange-attached inner ring element is located between a lower end surface of the outer ring element and an upper surface of the end plate element;
a shaft element fitted into the flange-attached inner ring element;
at least one first dynamic pressure groove formed on an inner circumferential surface of the outer ring element or an outer circumferential surface of the main body of the flange-attached inner ring element;
a second dynamic pressure groove is formed on a lower end surface of the outer ring element or an upper surface of the flange part of the flange-attached inner ring element;
a third dynamic pressure groove is formed on an upper surface of the end plate element or a lower surface of the flange part of the flange-attached inner ring element; and
lubricating oil filled in the minute gap between each of the facing surfaces corresponding to the first dynamic pressure groove, the second dynamic pressure groove, as well as the third dynamic pressure groove.

86. The hard disk drive device of claim 85 wherein the disk is chosen from a group consisting of a magnetic disk and an optical disk.

87. The hard disk drive device of claim 86 having two first dynamic pressure grooves that are spaced apart in the direction of the axis of rotation of the fluid dynamic bearing.

88. The hard disk drive device of claim 86, wherein the elements in which the first, second and third dynamic pressure grooves are formed are made of steel that can be hardened or stainless steel that can be hardened and these elements are hardened, ground and then the first, second and third dynamic pressure grooves are formed in the elements.

89. The hard disk drive device of claim 86, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

90. The hard disk drive device of claim 86, wherein a bearing container is formed by integrating the tubular case element and the end plate element.

91. The hard disk drive device of claim 86, further comprising a lubricating oil seal.

92. The hard disk drive device of claim 86, wherein the end plate element is coated with Diamond-Like Carbon.

93. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element fitted into the tubular case element;
a second outer ring element fitted into the tubular case element;
a flange-attached shaft element having a main body and a flange part inserted into the first outer ring element as well as the second outer ring element in a way such that the flange part thereof is located between a lower end surface of the first outer ring element and an upper surface of the second outer ring element;
a first dynamic pressure groove is formed on an inner circumferential surface of the first outer ring element or an outer circumferential surface of the main body of the flange-attached shaft element;
a second dynamic pressure groove is formed on an inner circumferential surface of the second outer ring element or an outer circumferential surface of the main body of the flange-attached shaft element;
a third dynamic pressure groove is formed on a lower surface of the first outer ring element or an upper surface of the flange part of the flange-attached shaft element;
a fourth dynamic pressure groove is formed on an upper surface of the second outer ring element or a lower surface of the flange part of the flange-attached shaft element; and
lubricating oil filled in the minute gap between each of the facing surfaces corresponding to the first dynamic pressure groove, the second dynamic pressure groove, the third dynamic pressure groove and the fourth dynamic pressure groove.

94. The hard disk drive device of claim 93 wherein the disk is chosen from a group consisting of a magnetic disk and an optical disk.

95. The hard disk drive device of claim 94, wherein
the main body of the flange-attached shaft element has two sections, each section having a different diameter.

96. The hard disk drive device of claim 94, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

97. The hard disk drive device of claim 94, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

98. The hard disk drive device of claim 94, wherein a bearing container is formed by integrating the tubular case element and the end plate element.

99. The hard disk drive device of claim 94, further comprising a lubricating oil seal.

100. The hard disk drive device of claim 94, wherein the end plate element is coated with Diamond-Like Carbon.

101. A hard disk drive device such as a HDD or DVD having at least one disk the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element fitted into the tubular case element;
a second outer ring element fitted into the tubular case element;
a flange-attached shaft element having a main body and a flange part inserted into the first outer ring element as well as the second outer ring element in such a way that the flange part thereof is located between a lower end surface of the second outer ring element and an upper surface of the end plate element;
a spacer element surrounding the flange part of the flange-attached shaft element for positioning the second outer ring element relative to the end plate element;
a first dynamic pressure groove formed on an inner circumferential surface of the first outer ring element or an outer circumferential surface of the main body of the flange-attached shaft element;
a second dynamic pressure groove formed on an inner circumferential surface of the second outer ring element or an outer circumferential surface of the main body of the flange-attached shaft element;
a third dynamic pressure groove formed on a lower surface of the second outer ring element or an upper surface of the flange part of the flange-attached shaft element;
a fourth dynamic pressure groove is formed on an upper surface of the end plate element or a lower surface of the flange part of the flange-attached shaft element; and
lubricating oil filled in the minute gap between each of the facing surfaces corresponding to the first dynamic pressure groove, the second dynamic pressure groove, the third dynamic pressure groove and the fourth dynamic pressure groove.

102. The hard disk drive device of claim 101 wherein the disk is chosen from a group consisting of a magnetic disk and an optical disk.

103. The hard disk drive device of claim 102, wherein
the main body of the flange-attached shaft element has two sections, each section having a different diameter.

104. The hard disk drive device of claim 102, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

105. The hard disk drive device of claim 102, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

106. The hard disk drive device of claim 102, wherein a bearing container is formed by integrating the tubular case element and the end plate element.

107. The hard disk drive device of claim 102, further comprising a lubricating oil seal.

108. The hard disk drive device of claim 102, wherein the end plate element is coated with Diamond-Like Carbon.

109. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element fitted into the tubular case element;
a second outer ring element fitted into the tubular case element;
a first inner ring element inserted into the first outer ring element;
a second flange-attached inner ring element having a flange part at one end, inserted into the second outer ring element in such a way that the flange part is located between the lower end surface of the second outer ring element and the upper surface of the end plate element;
a shaft element fitted into the first inner ring element as well as the second inner ring element;
a first dynamic pressure groove formed on an inner circumferential surface of the first outer ring element or an outer circumferential surface of the first inner ring element;
a second dynamic pressure groove formed on an inner circumferential surface of the second outer ring element or an outer circumferential surface of the second flange-attached inner ring element;
a third dynamic pressure groove formed on a lower surface of the second outer ring element or an upper surface of the flange part of the second flange-attached inner ring element;
a fourth dynamic pressure groove is formed on an upper surface of the end plate element or a lower surface of the flange part of the second flange-attached inner ring element; and
lubricating oil filled in the minute gap between each of the facing surfaces corresponding to the first dynamic pressure groove, the second dynamic pressure groove, the third dynamic pressure groove and the fourth dynamic pressure groove.

110. The hard disk drive device of claim 109 wherein the disk is chosen from a group consisting of a magnetic disk and an optical disk.

111. The hard disk drive device of claim 110, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

112. The hard disk drive device of claim 110, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

113. The hard disk drive device of claim 110, wherein a bearing container is formed by integrating the tubular case element and the end plate element.

114. The hard disk drive device of claim 110, further comprising a lubricating oil seal.

115. The hard disk drive device of claim 110, wherein the end plate element is coated with Diamond-Like Carbon.

116. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element having a large diameter fitted into the tubular case element;
a second outer ring element having a small diameter fitted into the tubular case element;
a stepped shaft element inserted into the first outer ring element as well as the second outer ring element in such a way that a large diameter part of the stepped shaft element is inserted into the first outer ring element and a small diameter part of the stepped shaft element is inserted into the second outer ring element,
a first dynamic pressure groove is formed on an inner circumferential surface of the first outer ring element or an outer circumferential surface of the large diameter part of the stepped shaft element;
a second dynamic pressure groove is formed on an inner circumferential surface of the second outer ring element or an outer circumferential surface of the small diameter part of the stepped shaft element;
a third dynamic pressure groove is formed on an upper surface of the second outer ring element or a surface of the step part of the stepped shaft element; and
lubricating oil is filled in the minute gap between each of the facing surfaces corresponding to the first dynamic pressure groove, the second dynamic pressure groove and the third dynamic pressure groove.

117. The hard disk drive device of claim 116 wherein the disk is chosen from a group consisting of a magnetic disk and an optical disk.

118. The hard disk drive device of claim 117, wherein the elements in which the first, second and third dynamic pressure grooves are formed are made of steel that can be hardened or stainless steel that can be hardened and these elements are hardened, ground and then the first, second and third dynamic pressure grooves are formed in the elements.

119. The hard disk drive device of claim 117, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

120. The hard disk drive device of claim 117, wherein a bearing container is formed by integrating the tubular case element and the end plate element.

121. The hard disk drive device of claim 117, further comprising a lubricating oil seal.

122. The hard disk drive device of claim 117, wherein the end plate element is coated with Diamond-Like Carbon.

123. A hard disk drive device such as a HDD or DVD having at least one disk, the hard disk drive device including a motor, the motor having a fluid dynamic bearing unit composed of a plurality of modularized elements, the fluid dynamic bearing unit comprising:
a tubular case element having a cylindrical shaped inner circumferential surface;
an end plate element closing the lower end part of the tubular case element;
a first outer ring element having a small diameter fitted into the tubular case element;
a second outer ring element having a large diameter fitted into the tubular case element;
a stepped shaft element inserted into the first outer ring element as well as the second outer ring element in such a way that a small diameter part of the stepped shaft element is inserted into the first outer ring element and a large diameter part of the stepped shaft element is inserted into the second outer ring element;
a first dynamic pressure groove formed on an inner circumferential surface of the first outer ring element or an outer circumferential surface of the small diameter part of the stepped shaft element;
a second dynamic pressure groove is formed on an inner circumferential surface of the second outer ring element or an outer circumferential surface of the large diameter part of the stepped shaft element;
a third dynamic pressure groove is formed on a lower end surface of the first outer ring element or a surface of the step part of the stepped shaft element;
a fourth dynamic pressure groove is formed on an upper surface of the end plate element or a lower end surface of the stepped shaft element; and
lubricating oil is filled in the minute gap between each of the facing surfaces corresponding to the first dynamic pressure groove, the second dynamic pressure groove, the third dynamic pressure groove and the fourth dynamic pressure groove.

124. The hard disk drive device of claim 123 wherein the disk is chosen from a group consisting of a magnetic disk and an optical disk.

125. The hard disk drive device of claim 124, wherein the elements in which the first, second, third and fourth dynamic pressure grooves are formed are made of steel that can be hardened or stainless steel that can be hardened and these elements are hardened, ground and then the first, second, third and fourth dynamic pressure grooves are formed in the elements.

126. The hard disk drive device of claim 124, wherein the tubular case element further comprises a step part formed in the lower end part of the tubular case element, the step part being finished at the same time as the inner circumferential surface of the tubular case element and the end plate element being fitted in the step part, thereby closing the lower end part of the tubular case element.

127. The hard disk drive device of claim 124, wherein a bearing container is formed by integrating the tubular case element and the end plate element.

128. The hard disk drive device of claim 124, further comprising a lubricating oil seal.

129. The hard disk drive device of claim 124, wherein the end plate element is coated with Diamond-Like Carbon.
